(19) United States
(12) Patent Application Publication
(10) Pub. No.: US 2024/0220794 A1
(43) Pub. Date: Jul. 4, 2024

(54) TRAINING SYSTEMS AND OPERATING METHOD THEREOF

(71) Applicant: UNIST (ULSAN NATIONAL INSTITUTE OF SCIENCE AND TECHNOLOGY), Ulsan (KR)

(72) Inventors: Young-ri CHOI, Ulsan (KR); Yeonhyeok Jeong, Ulsan (KR); Seungmin Lee, Ulsan (KR); Seonghyeon Jue, Ulsan (KR)

(73) Assignee: UNIST (ULSAN NATIONAL INSTITUTE OF SCIENCE AND TECHNOLOGY), Ulsan (KR)

(21) Appl. No.: 18/398,922

(22) Filed: Dec. 28, 2023

(30) Foreign Application Priority Data
Dec. 30, 2022 (KR) 10-2022-0191027
Nov. 8, 2023 (KR) 10-2023-0153939

(51) Int. Cl. G06N 3/08

(52) U.S. Cl. CPC G06N 3/08

(57) ABSTRACT

Provided are a training system and an operating method thereof. The training system includes a job proxy configured to partition a training job corresponding to a neural network model into a plurality of microservices respectively executed by a plurality of logical workers, and a scheduler configured to schedule the plurality of microservices for a plurality of processing units, respectively, wherein the plurality of microservices includes a plurality of first microservices executed by a first logical worker among the plurality of logical workers and a plurality of second microservices executed by a second logical worker among the plurality of logical workers, and the scheduler is configured to schedule the plurality of first microservices and the plurality of second microservices to any one processing unit among the plurality of processing units based on an availability status of the plurality of processing units.

### CROSS-REFERENCE TO RELATED APPLICATION

This application is based on and claims priority under 35 U.S.C. § 119 to Korean Patent Application No. 10-2022-0191027, filed on Dec. 30, 2022, in the Korean Intellectual Property Office and Korean Patent Application No. 10-2023-0153939, filed on Nov. 8, 2023, in the Korean Intellectual Property Office, the disclosure of which is incorporated by reference herein in its entirety.

### BACKGROUND

### 1. Field

The disclosure relates to a training system and an operating method thereof, and more particularly, to a microservice-based training system and an operating method thereof.

### 2. Description of the Related Art

Recently, applications that require high throughput computing (HTC) have expanded to various fields, and the number thereof is growing.

As a result, a shared cluster environment that shares resources by multiple users has emerged to effectively execute the application that requires HTC. In particular, training of a deep neural network (DNN) is mostly a long-running task that uses multiple graphic processing units (GPUs) dedicatedly. However, in a shared cluster environment, limited resources are divided to users to perform their own work, and the amount of resources necessary to execute their own work may be limited. As a result, the demand for a resource management policy, which is optimally allocated and scheduled to multiple users, has increased.

In a serverless system, such as Amazon Lambda and Google Cloud Function, which has been widely used recently, HTC may be executed using a microservice that is a function unit. A microservice execution method means splitting a single application into multiple small applications to configure each application with a small and independent service. The microservice execution method is executed with independent microservices, and thus it is possible to flexibly use resources. Still, it is difficult to use the current microservice execution method in training a DNN that is generally executed monolithically.

Accordingly, research on an efficient resource management system that utilizes a serverless system using the microservice execution method in training a DNN is needed.

### SUMMARY

Additional aspects will be set forth in part in the description which follows and, in part, will be apparent from the description, or may be learned by practice of the presented embodiments of the disclosure.

According to an aspect of the disclosure, a training system includes a job proxy configured to partition a training job corresponding to a neural network model into a plurality of microservices respectively executed by a plurality of logical workers, and a scheduler configured to schedule the plurality of microservices to a plurality of processing units, respectively, wherein the plurality of microservices include a plurality of first microservices executed by a first logical worker among the plurality of logical workers and a plurality of second microservices executed by a second logical worker among the plurality of logical workers, and the scheduler is configured to schedule the plurality of first microservices and the plurality of second microservices to any one processing unit among the plurality of processing units based on an availability status of the plurality of processing units.

The scheduler may be further configured to sequentially schedule the plurality of first microservices and the plurality of second microservices to the any one processing unit in accordance with a number of available processing units being less than a number of the plurality of logical workers.

The scheduler may be configured to schedule the plurality of first microservices and the plurality of second microservices to a same container.

The plurality of microservices may each include a function that processes a plurality of minibatches obtained by partitioning training data for the training job, and the scheduler may be configured to schedule minibatch processing of any one of the plurality of first microservices and minibatch processing of any one of the plurality of second microservices to be executed in multiple phases in the any one processing unit.

The training system may further include a resource manager.

The resource manager may be configured to allocate the plurality of processing units in units of 2ⁿ to the training job corresponding to the neural network model.

When the training job corresponding to the neural network model includes 2k logical workers, the resource manager may be configured to allocate the plurality of processing units in units of any one of divisors of 2k, and when the training job includes 2k−1 logical workers, the resource manager may be configured to allocate the plurality of processing units in units of any one of divisors of 2k−1 or divisors of 2k, except for 1 and 2k.

The resource manager may be configured to respectively allocate the plurality of processing units to the plurality of training jobs corresponding to a plurality of neural network models.

The resource manager may further allocate a processing unit present in a cluster in an order from a training job having a shortest remaining service time and allocate a remaining processing unit to a training job to which less processing units than required processing units are allocated in accordance with presence of the remaining processing unit in the cluster.

The resource manager may be configured to allocate a processing unit to each of the plurality of training jobs and reallocate the processing unit to a queuing training job when a queuing time of a queuing training job is greater than an expected increase time when one or more training jobs are executed in multiple phases, in accordance of presence of the queuing training job stored in a queue.

The plurality of microservices may include a computation function that computes respective weights for a plurality of minibatches, and an aggregation function that computes a global parameter obtained by aggregating the respective weights for the plurality of minibatches.

A first computation function of the plurality of first microservices and a second computation function of the plurality of second microservices may be sequentially executed in a same iteration.

A first computation function of the plurality of first microservices may read the global parameter and transfer the global parameter to a second computation function of the plurality of second microservices.

The plurality of microservices may include a plurality of third microservices executed by a third logical worker among the plurality of logical workers and a plurality of fourth microservices executed by a fourth logical worker among the plurality of logical workers, the scheduler may schedule the plurality of third microservices and the plurality of fourth microservices to another processing unit among the plurality of processing units, and the plurality of third microservices may be executed in parallel with the plurality of first microservices.

According to another aspect of the disclosure, an operating method of a training system includes partitioning a training job corresponding to a neural network model into a plurality of microservices respectively executed by a plurality of logical workers; and scheduling the plurality of microservices to a plurality of processing units, respectively. The scheduling may include scheduling a plurality of first microservices executed by a first logical worker among the plurality of logical workers and a plurality of second microservices executed by a second logical worker among the plurality of logical workers to any one processing unit among the plurality of processing units based on an availability status of the plurality of processing units.

The scheduling may include sequentially scheduling the plurality of first microservices and the plurality of second microservices to the any one processing unit when a number of available processing units is determined to be less than a number of the plurality of logical workers.

The scheduling may include scheduling the plurality of first microservices and the plurality of second microservices to a same container.

The operating method may further include scheduling minibatch processing of any one of the plurality of first microservices and minibatch processing of any one of the plurality of second microservices to be executed in multiple phases in the any one processing unit.

The operating method may further include allocating the plurality of processing units in units of 2ⁿ to the training job corresponding to the neural network model.

The operating method may further include respectively allocating the plurality of processing units to the plurality of training jobs corresponding to a plurality of neural network models.

The respectively allocating of the plurality of processing units to the plurality of training jobs may include allocating a processing unit present in a cluster in an order from a training job having a shortest remaining service time, and allocating a remaining processing unit to a training job to which less processing units than required processing units are allocated as the remaining processing unit is present in the cluster.

The operating method may further include respectively allocating the plurality of processing units to the plurality of training jobs corresponding to a plurality of neural network models; and reallocating the processing unit to a queuing training job if a queuing time of a queuing training job is greater than an expected increase time when one or more training jobs are executed in multiple phases, in according with presence of presence of the queuing training job stored in a queue.

The plurality of microservices may include a plurality of third microservices executed by a third logical worker among the plurality of logical workers and a plurality of fourth microservices executed by a fourth logical worker among the plurality of logical workers, and the scheduling may include scheduling the plurality of third microservices and the plurality of fourth microservices for another processing unit among the plurality of processing units, and executing the plurality of third microservices in parallel with the plurality of first microservices.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for explaining a concept of an operation of a training system according to an embodiment;

FIG. 2 is a flowchart illustrating an operating method of a training system according to an embodiment;

FIG. 3 is a diagram for explaining a plurality of microservices and a plurality of logical workers in a training system according to an embodiment;

FIG. 4 is a diagram showing an example of a process of scheduling a processing unit to a training job in a training system, according to an embodiment;

FIG. 5 is a diagram showing a process of executing a plurality of microservices in a training system according to an embodiment;

FIG. 6 is a diagram showing a process of executing a plurality of microservices through a processing unit in a training system according to an embodiment;

FIGS. 7 and 8 show an example of a training job scheduled to processing units in a training system according to an embodiment;

FIG. 9 is a flowchart illustrating an operating method of a training system according to an embodiment;

FIG. 10 is a diagram showing the configuration of a training system according to an embodiment;

FIG. 11 shows an example of a process of allocating processing units to a plurality of training jobs in a training system according to an embodiment;

FIG. 12 shows an example of a process of allocating processing units to a plurality of training jobs in a training system according to an embodiment;

FIG. 13 is a flowchart of a method of allocating processing units to a plurality of training jobs in a training system according to an embodiment;

FIG. 14 shows an example of a process of allocating processing units to a plurality of training jobs in a training system according to an embodiment;

FIG. 15 shows an example of a process of allocating processing units to a plurality of training jobs in a training system according to an embodiment;

FIG. 16 is a flowchart of a method of allocating processing units to a plurality of training jobs in a training system according to an embodiment; and

FIG. 17 is a block diagram of a training system according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The specification explains and discloses the principles of embodiments to clarify the scope of the claims and for those of ordinary skill in the art to which the embodiments belong to easily implement the embodiment. The disclosed embodiments may be implemented in various forms.

The same reference numeral for the entire specification refers to the same component. The specification does not explain all the elements of the embodiments, and omits a repeated explanation between the general contents or embodiments in the art to which the embodiments belong. The terms “module” or “unit” described in the specification may be implemented by hardware, software, a firmware, or a combination of two or more, and in some embodiment, it is possible for multiple “modules” or “units” to be implemented as one component, or for one “module” or “unit” to include multiple components.

In the following description of embodiments, a detailed description of known related art will be omitted when it is determined that the subject matter of the present disclosure is unnecessarily obscured. The numbers used in the description of the specification (e.g., first, second, and the like) are merely identifier symbols for distinguishing one component from other components.

Hereinafter, operating principles of embodiments and various embodiments will be described with reference to the accompanying drawings.

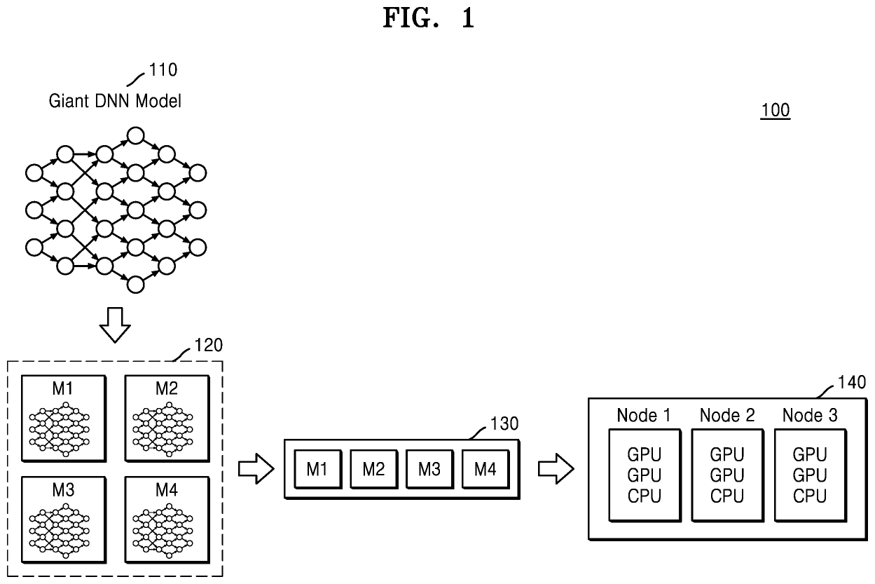

FIG. 1 is a diagram for explaining a concept of an operation of a training system according to an embodiment.

Referring to FIG. 1, a training system 100 may train a neural network model. According to an embodiment, the neural network model may be a giant deep neural network (DNN) model 110. The giant DNN model 110 may be trained by the training system 100, and series of training processes may be referred to as a training job 120.

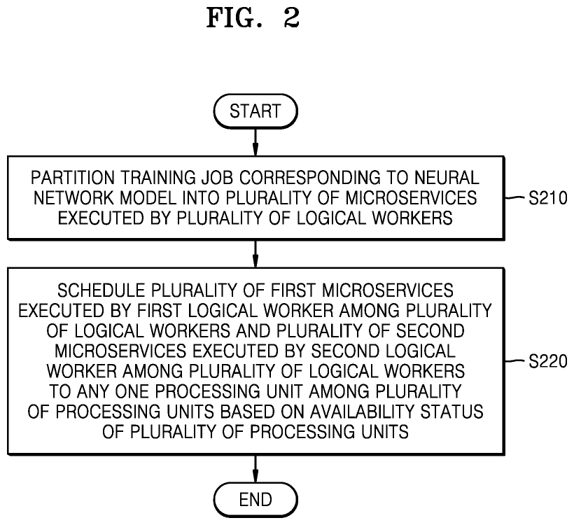

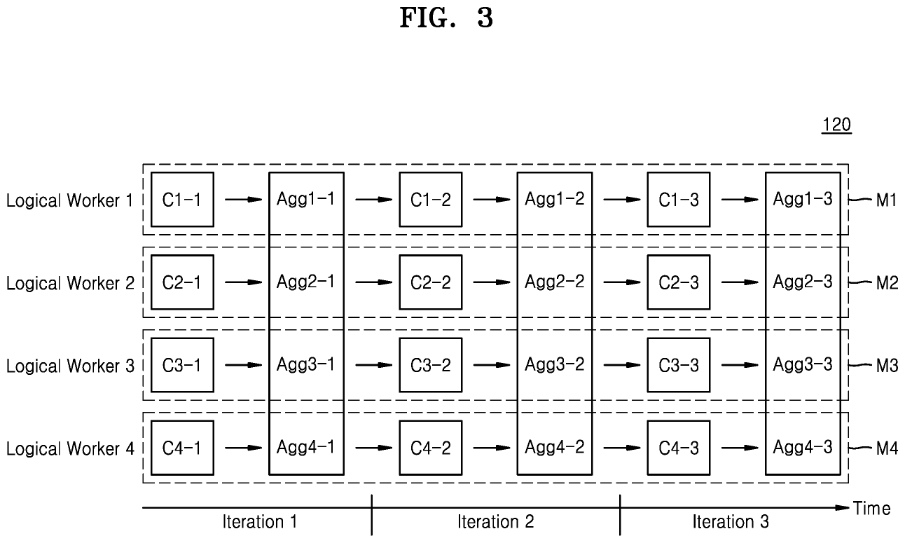

The training job of machine learning may be executed by one worker or executed by multiple workers to improve performance. The worker may include, for example, a graphic processing unit (GPU). However, in an embodiment, a concept of a logical worker may be used for executing the training job in the form of multiple microservices. Detailed descriptions of the logical worker are given below with reference to FIGS. 2 and 3.

In an embodiment, the training job 120 may include a plurality of microservices M1, M2, M3, and M4. In the disclosure, the microservice may be a function, which is a unit of computation in a serverless system, and one application may be executed in a chain of microservices (or a sequence of microservices). The microservice may be a concept obtained by partitioning the training data for training the neural network model 110 by a microservice unit. According to an embodiment, in the training system 100 in which training data includes a plurality of minibatches, a microservice may correspond to a minibatch processing function. For example, the microservice may process forward pass and backward pass for one minibatch. For example, the microservice may correspond to a chain for processing a plurality of minibatches, which sequentially processes a plurality of minibatches.

According to an embodiment, the microservice simply means one processing unit in the training system 100, and an object for processing may vary in some embodiments.

In the training system 100 according to an embodiment, the training job 120 for training of the giant DNN model 110 may be executed in a chain of the plurality of microservices M1, M2, M3, and M4, which are function-level works. The training system 100 may submit the plurality of microservices M1, M2, M3, and M4 to a scheduler 130.

According to an embodiment, the scheduler 130 may add the plurality of microservices M1, M2, M3, and M4 to a queue of the scheduler 130. The scheduler 130 may schedule the plurality of microservices M1, M2, M3, and M4 to a cluster 140. According to an embodiment, the scheduler 130 may sequentially schedule at least some of the plurality of microservices M1, M2, M3, and M4 to any one processing unit. The scheduler 130 may perform scheduling on a plurality of processing units in consideration of the locality, overhead, interference, and the like of each of the plurality of microservices M1, M2, M3, and M4.

According to an embodiment, the cluster 140 may execute the training job 120 to train the giant DNN model 110. The cluster 140 is a distributed processing system obtained by combining a plurality of nodes via a high-speed network and includes heterogeneous resources including various types of GPUs or CPUs with different computation capacities and memory capacities to perform parallel computing. According to an embodiment, a plurality of nodes (e.g., Node 1, Node 2, and Node 3 of FIG. 1) of the cluster 140 may each include a plurality of processing units corresponding to a GPU or CPU, and the plurality of processing units included in each of the plurality of nodes may be allocated to the training job 120.

According to an embodiment, the training system 100 may execute a plurality of microservices through a serverless system. The serverless system refers to a cloud development model that allows a developer to build and execute an application without having to manage a server, and the developer may package codes to a container for distribution. According to an embodiment, a microservice based on a serverless system may be executed independently and may perform communication through a storage.

Unlike scheduling of an existing dedicated GPU use and all-or-nothing method (e.g., a method that does not allocate resources when available resources are less than required resources), the training system 100 according to an embodiment may dynamically schedule a non-designed GPU to the plurality of microservices M1, M2, M3, and M4 to be executed independently. Accordingly, the training system 100 may flexibly schedule resources to train the training job 120. Accordingly, it may be possible to improve the efficiency of the training system 100 by dynamically allocating and scheduling limited resources in a shared cluster environment.

According to an embodiment, the training system 100 may allocate and schedule less resources than the resources required to execute the training job 120. The training system 100 may execute the training job 120 with a less resources than the required resources. For example, four processing units may be required to execute the plurality of microservices M1, M2, M3, and M4 included in the training job 120. For example, the plurality of microservices M1, M2, M3, and M4 may be scheduled to one processing unit belonging to the cluster 140. Alternatively, for example, at least some (e.g., M1 and M2) of the plurality of microservices M1, M2, M3, and M4 may be scheduled to any one of a plurality of processing units, and at least other some (e.g., M3 and M4) of the plurality of microservices M1, M2, M3, and M4 may be scheduled to another processing unit of the plurality of processing units.

According to an embodiment, the plurality of microservices M1, M2, M3, and M4 included in the training job 120 may be trained in parallel with each other by the cluster 140. According to an embodiment, the training system 100 may improve the performance of the cluster as well as the utilization of heterogeneous GPU resources of the cluster by training the giant DNN model 110 through data parallel processing.

According to an embodiment, at least some of the plurality of microservices M1, M2, M3, and M4 included in the training job 120 may be sequentially executed by one processing unit belonging to the cluster 140. In this case, at least some of the plurality of microservices M1, M2, M3, and M4 may be executed in multiple phases by one processing unit. For example, M1 and M2 may be executed sequentially by any one processing unit, and M3 and M4 may be executed sequentially by another processing unit.

FIG. 2 is a flowchart illustrating an operation method of a training system according to an embodiment.

Referring to FIG. 2, in operation S210, the training system 100 according to an embodiment partitions the training job 120 corresponding to a neural network model into a plurality of microservices that are executed by a plurality of logical workers, respectively. For example, the training job 120 may be partitioned into the plurality of microservices M1, M2, M3, and M4 through the training system 100. The plurality of microservices M1, M2, M3, and M4 may be executed by the plurality of logical workers, respectively.

In the disclosure, the training job may be partitioned into the plurality of microservices M1, M2, M3, and M4, and each of the plurality of microservices M1, M2, M3, and M4 may be executed in a chain of microservices by a logical worker. The logical worker may not actually exist but may be a worker that executes each of the plurality of microservices M1, M2, M3, and M4 in a chain of microservices. The logical workers may sequentially execute the microservices in the form of a chain and thus may replace an ordinary operator by a GPU. However, unlike ordinary workers, the logical worker may be physically decoupled from a GPU during execution. In the disclosure, the fact that a microservice is executed by a logical worker may mean that the giant DNN model 110 is trained by processing a chain of the microservices and computing a weight.

In the disclosure, one logical worker executes a chain of microservices, and thus the number of logical workers may correspond to the number of GPU resources required to execute the chain of microservices to perform training. In other words, the number of logical workers may correspond to the number of GPU resources for executing chains of the microservices belonging to the training job in parallel with each other.

In operation S220, based on an availability status of a plurality of processing units included in the cluster 140, the training system 100 according to an embodiment may schedule a plurality of first microservices executed by a first logical worker among a plurality of logical workers and a plurality of second microservices executed by a second logical worker among the plurality of logical workers to any one of the plurality of processing units. Accordingly, the first microservice and the second microservice may be sequentially executed in the same iteration through the same processing unit. That is, one processing unit may execute two or more microservices sequentially, and one-time iteration may be performed in multiple phases in which two or more microservices are sequentially by one processing unit. In the disclosure, the availability status of the processing unit may mean whether a processing unit allocated to the training job 120 is present or not or the number of the allocated processing units.

For example, the training system 100 may sequentially schedule the plurality of first microservices and the plurality of second microservices to any one processing unit based on that it is determined that the number of available processing units is less than the number of logical workers. In the disclosure, the available processing unit may mean a processing unit corresponding to the availability status.

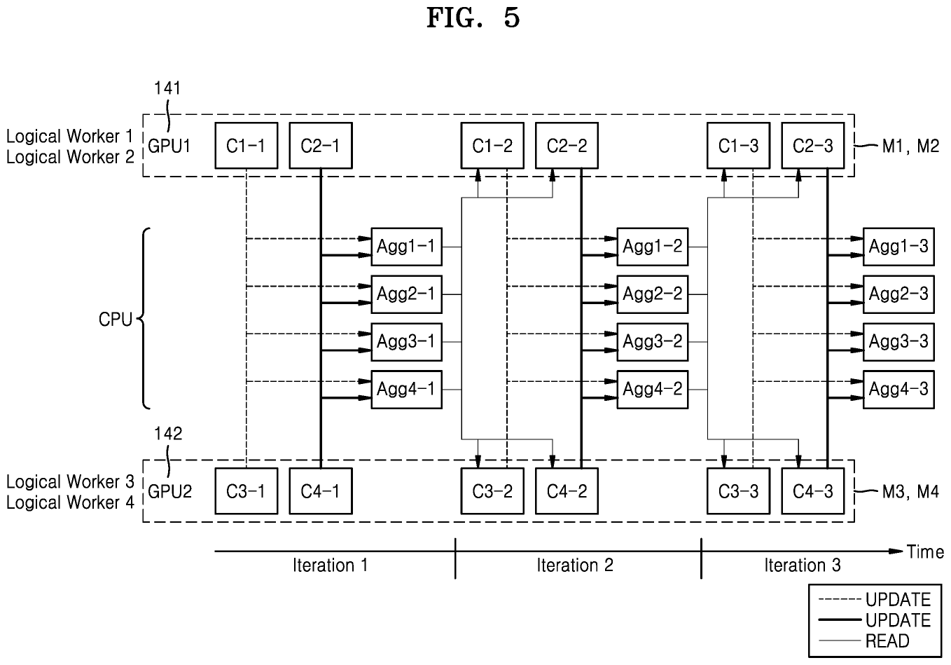

The plurality of microservices may correspond to minibatches obtained by partitioning training data. Accordingly, processing of a minibatch of any one of the plurality of first microservices and processing of a minibatch of any one of the plurality of second microservices may be sequentially performed by any one processing unit. That is, processing of a minibatch of any one of the plurality of first microservices and processing of a minibatch of any one of the plurality of second microservices may belong to the same iteration (refer to FIG. 5).

The training system 100 according to an embodiment may schedule multiple logical workers to the same processing unit. In this case, the plurality of microservices M1, M2, M3, and M4 may be executed sequentially in the same processing unit.

The training system 100 according to an embodiment may also schedule multiple logical workers in parallel with each other like a general training system. In this case, the plurality of microservices M1, M2, M3, and M4 may be executed in parallel with each other by a plurality of logical workers.

FIG. 3 is a diagram for explaining a plurality of microservices and a plurality of logical workers in a training system according to an embodiment.

Referring to FIG. 3, the training job 120 may include a plurality of first microservices M1, a plurality of second microservices M2, a plurality of third microservices M3, and a plurality of fourth microservices M4. According to an embodiment, each of the plurality of first microservices M1, the plurality of second microservices M2, the plurality of third microservices M3, and the plurality of fourth microservices M4 may be partitioned for each minibatch. That is, each of the plurality of first microservices M1, the plurality of second microservices M2, the plurality of third microservices M3, and the plurality of fourth microservices M4 may be present in the form of a chain of microservices, which is partitioned for each minibatch.

The plurality of first microservices M1, the plurality of second microservices M2, the plurality of third microservices M3, and the plurality of fourth microservices M4 may be executed in parallel with each other by a plurality of logical workers (logical worker 1, logical worker 2, logical worker 3, and logical worker 4) (hereinafter referred to as LW1, LW2, LW3, and LW4). The fact that the plurality of logical workers LW1, LW2, LW3, and LW4 execute the plurality of microservices M1, M2, M3, and M4 may mean that the training job 120 is executed to perform training on the giant DNN model 110. For convenience of explanation, an example in which there are four chains of microservices and four logical workers is illustrated, but an embodiment is not limited thereto.

According to an embodiment, the training system 100 may execute the training job 120 in the form of a microservice without allocation of a dedicated GPU through the plurality of logical workers LW1, LW2, LW3, and LW4. For example, the first to fourth logic workers LW1, LW2, LW3, and LW4 may execute the plurality of first to fourth microservices M1, M2, M3, and M4, respectively.

For example, the plurality of first microservices M1 may be executed in a chain of the plurality of first microservices M1 by the first logical worker LW1. The plurality of first microservices M1 may include first computation functions C: C1-1, C1-2, and C1-3 and first aggregation functions Agg: Agg1-1, Agg1-2, and Agg1-3. The first logical worker LW1 may sequentially execute the plurality of first microservices M1 including a chain of the first computation functions C1-1, C1-2, and C1-3 and the first aggregation functions Agg1-1, Agg1-2, and Agg1-3.

For example, the plurality of second microservices M2 may be executed in a chain of the plurality of second microservices M2 by the second logical worker LW2. The plurality of second microservices M2 may include second computation functions C: C2-1, C2-2, and C2-3 and second aggregation functions Agg: Agg2-1, Agg2-2, and Agg2-3. The second logical worker LW2 may sequentially execute the plurality of second microservices M2 including a chain of the second computation functions C2-1, C2-2, and C2-3 and the second aggregation functions Agg2-1, Agg2-2, and Agg2-3.

For example, the plurality of third microservices M3 may be executed in a chain of the plurality of third microservices M3 by the third logical worker LW3. The plurality of third microservices M3 may include third computation functions C: C3-1, C3-2, and C3-3 and third aggregation functions Agg: Agg3-1, Agg3-2, and Agg3-3. The third logical worker LW3 may sequentially execute the plurality of third microservices M3 including a chain of the third computation functions C3-1, C3-2, and C3-3 and the third aggregation functions Agg3-1, Agg3-2, and Agg3-3.

For example, the plurality of fourth microservices M4 may be executed in a chain of the plurality of fourth microservices M4 by the fourth logical worker LW4. The plurality of fourth microservices M4 may include fourth computation functions C: C4-1, C4-2, and C4-3 and fourth aggregation functions Agg: Agg4-1, Agg4-2, and Agg4-3. The fourth logical worker LW4 may sequentially execute the plurality of fourth microservices M4 including a chain of the fourth computation functions C4-1, C4-2, and C4-3 and the fourth aggregation functions Agg4-1, Agg4-2, and Agg4-3.

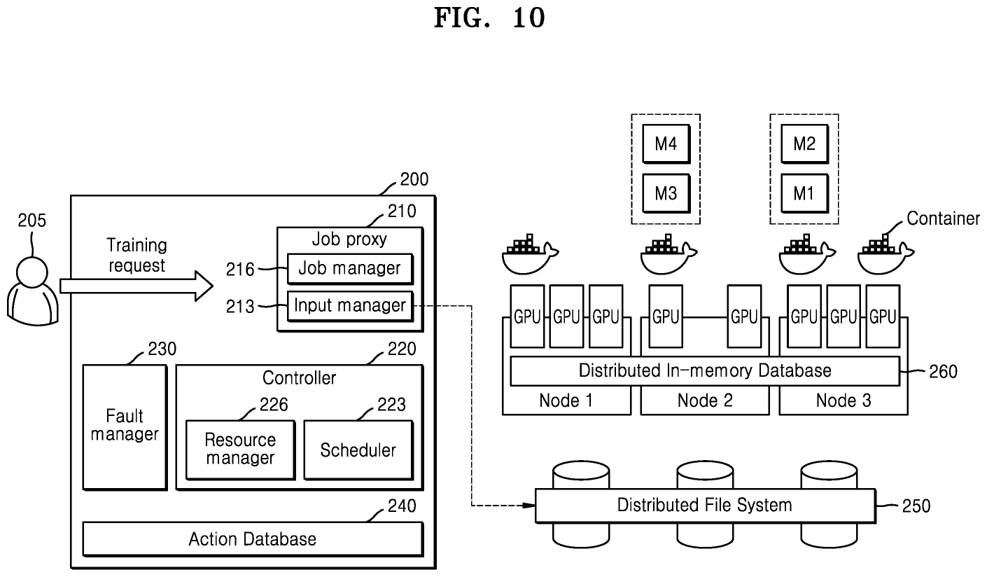

The plurality of logical workers LW1, LW2, LW3, and LW4 may partition the training job 120 and execute the same in parallel with each other based on microservices. As a result, efficiency corresponding to execution of the training job 120 through four GPUs may be achieved. According to an embodiment, the microservice may include the computation functions C and the aggregation functions Agg. In the disclosure, the computation functions C may be referred to as a first type of microservice, and the aggregation functions Agg may be referred to as a second type of microservice. Arrows shown between the aggregate functions and the computation functions in the drawing indicate data communication (or data dependency) between the functions. In the disclosure, each function may perform indirect communication through a storage (e.g., distributed in-memory database 260 (refer to FIG. 10)), not direct communication.

The computation functions C may be a work for computing a model parameter, that is, a weight by the plurality of logical workers LW1, LW2, LW3, and LW4. The model parameter may correspond to a value used in each layer of a DNN, for example, a model parameter of a neural network or a gradient. The computation functions C may be performed through repetitive operations from forward pass and backward pass, and many parameters may be created by the repetitive operations. The repetitive operation may be referred to as “iteration,” and a large amount of iteration may be performed for optimized training. The computation functions C may compute a weight by processing a minibatch for each iteration. The computed weight may be updated in the in-memory database 260 (FIG. 10) for synchronization. Hereinafter, the “parameter” may be understood to have the same meaning as the “weight.”

For example, the first computation functions C1-1, C1-2, and C1-3 of the plurality of first microservices M1 may include the first computation function C1-1 for performing first iteration (iteration 1), the first computation function C1-2 for performing second iteration (iteration 2), and the first computation function C1-3 for performing third iteration (iteration 3).

For example, the second computation functions C2-1, C2-2, and C2-3 of the plurality of second microservices M2 may include the second computation function C2-1 for performing the first iteration (iteration 1), the second computation function C2-2 for performing the second iteration (iteration 2), and the second computation function C2-3 for performing the third iteration (iteration 3). The third computation functions C3-1, C3-2, and C3-3 of the plurality of third microservices M3 may include the third computation function C3-1 for performing the first iteration (iteration 1), the third computation function C3-2 for performing the second iteration (iteration 2), and the third computation function C3-3 for performing the third iteration (iteration 3). The fourth computation functions C4-1, C4-2, and C4-3 of the plurality of fourth microservices M4 may include the fourth computation function C4-1 for performing the first iteration (iteration 1), the fourth computation function C4-2 for performing the second iteration (iteration 2), and the fourth computation function C4-3 for performing the third iteration (iteration 3).

The aggregation function Agg may be a work for aggregating weights that are computed by the plurality of logical workers LW1, LW2, LW3, and LW4, respectively. The aggregation functions Agg may also be executed using a CPU resource alone. As the aggregation functions Agg use the CPU resource, the plurality of aggregation functions (e.g., Agg1-1, Agg2-1, Agg3-1, and Agg4-1) may be simultaneously executed. The aggregation functions Agg may aggregate the weights computed by processing the computation functions C to synchronize the weights. The synchronized weights may each be a global parameter. For example, the aggregation functions Agg may update the global parameter in the in-memory database 260. The global parameter may be updated in the computation functions C, which perform a subsequent iteration by the aggregation functions Agg.

The computation functions C, which perform a subsequent iteration, may read the global parameter updated by the aggregation function Agg and process a minibatch for each iteration to compute a weight.

For example, the plurality of first microservices M1 may include the first aggregate functions Agg1-1, Agg1-2, and Agg1-3, the plurality of second microservices M2 may include the second aggregate functions Agg2-1, Agg2-2, and Agg2-3, the plurality of third microservices M3 may include the third aggregate functions Agg3-1, Agg3-2, and Agg3-3, and the plurality of fourth microservices M4 may include the fourth aggregation functions Agg4-1, Agg4-2, and Agg4-3.

For example, in the first iteration (iteration 1), the first aggregation function Agg1-1 of the plurality of first microservices M1, the second aggregation function Agg2-1 of the plurality of second microservices M2, the third aggregation function Agg3-1 of the plurality of third microservices M3, and the fourth aggregation function Agg4-1 of the plurality of fourth microservices M4 may aggregate the weight computed by the first computation function C1-1, the weight computed by the second computation function C2-1, the weight computed by the third computation function C3-1, and the weight computed by the fourth computation function C4-1 to update the global parameter. The updated global parameter may be updated in the first computation function C1-2, the second computation function C2-2, the third computation function C3-2, and the fourth computation function C4-2, which perform the subsequent iteration (e.g., iteration 2), by the first aggregation function Agg1-1, the second aggregation function Agg2-1, the third aggregation function Agg3-1, and the fourth aggregation function Agg4-1. Each of the first computation function C1-2, the second computation function C2-2, the third computation function C3-2, and the fourth computation function C4-2, which perform the subsequent iteration (iteration 2) may read the updated global parameter and compute a new weight.

As described above, based on update of the aggregation functions Agg1-1, Agg2-1, Agg3-1, and Agg4-1, each of the first computation function C1-2, the second computation function C2-2, the third computation function C3-2, and the fourth computation function C4-2 may compute a weight in the subsequent iteration (iteration 2). The computed weight may be updated in the computation functions C1-3, C2-3, C3-3, and C4-3 of a subsequent iteration (iteration 3) by the aggregation functions Agg1-2, Agg2-2, Agg3-2, and Agg4-2.

According to an embodiment, four logical workers may train a training job using data parallelism and synchronize the weights through bulk synchronous parallel (BSP). This will be described below with reference to FIG. 10.

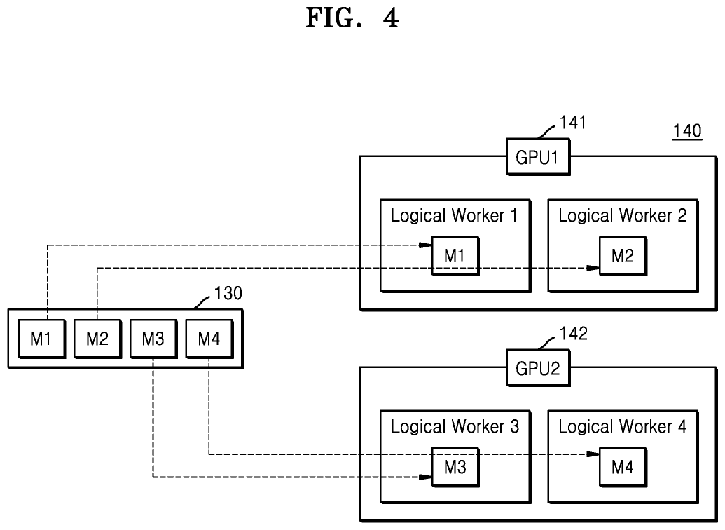

FIG. 4 is a diagram showing an example of a process of scheduling a processing unit to a training job in a training system, according to an embodiment.

Referring to FIG. 4, the training system 100 according to an embodiment may schedule a plurality of logical workers to a plurality of processing units included in the cluster 140 based on the availability status of the plurality of processing units.

In a shared cluster environment that shares resources by multiple users, limited resources are divided to the users to perform their own works. Accordingly, the number of processing units in an availability status may be less than the number of logical workers required to execute the training job.

According to an embodiment, the training job may be partitioned into a plurality of microservices in the training system, and the plurality of microservices may be executed independently. The plurality of microservices may be executed independently, and thus even if the number of the processing units in the availability status is less than the number of the logical workers required to execute the plurality of microservices, training may be performed through dynamic resource scheduling.

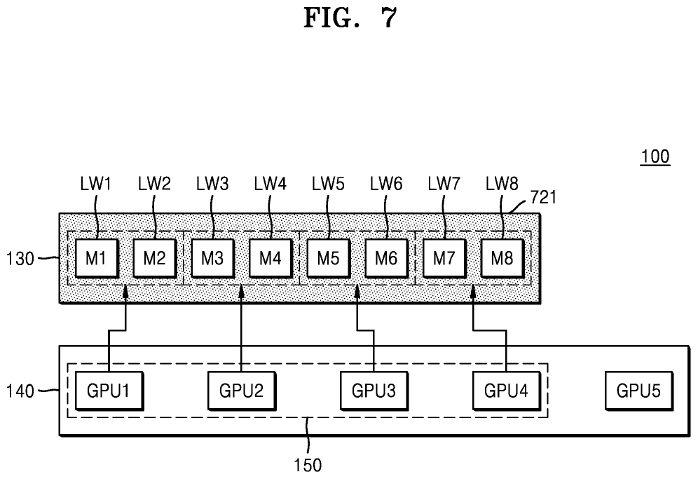

For example, the cluster 140 may include a plurality of processing units and may include a first processing unit 141 and a second processing unit 142. For example, the first processing unit 141 and the second processing unit 142 may be allocated to the training job 120 by a resource manager 150 (FIG. 7). The resource manager 150 according to an embodiment may allocate one or more processing units to a training job submitted to the cluster 140. The resource manager 150 according to an embodiment may allocate less processing units than logical workers required to execute the training job 120. For example, the resource manager 150 may allocate the first processing unit 141 and the second processing unit 142 to the training job 120 including the plurality of microservices M1, M2, M3, and M4. The first processing unit 141 and the second processing unit 142 may be resources allocated to the training job 120 and may be an available processing unit for the training job 120.

According to an embodiment, the scheduler 130 may dynamically schedule the plurality of microservices M1, M2, M3, and M4 to two processing units. The scheduler 130 may schedule the processing unit to the training job 120 even if the number of processing units allocated to the training job 120 is less than the number of required resources. For example, the first processing unit 141 may be scheduled to the plurality of first microservices M1 and the plurality of second microservices M2 among the plurality of microservices M1, M2, M3, and M4, and the second processing unit 142 may be scheduled to the third microservices M3 and the plurality of fourth microservices M4 among the plurality of microservices M1, M2, M3, and M4.

For example, the plurality of first microservices M1 and the plurality of second microservices M2 may be sequentially executed during the same iteration through the first processing unit 141. That is, the first processing unit 141 may execute two microservices sequentially, and one-time iteration may be performed in multiple phases. For example, the plurality of third microservices M3 and the plurality of fourth microservices M4 may be sequentially executed during the same iteration through the same second processing unit 142. In this case, the plurality of first microservices M1 executed by the first processing unit 141 and the plurality of third microservices M3 executed by the second processing unit 142 may be executed in parallel with each other.

The scheduler 130 may schedule a container to execute a microservice to a node of the cluster 140. To reduce overhead by cold-start of the container, the scheduler 130 may schedule a microservice to perform training using the same container. The container may be continuously reused for the same training job and thus may be used as a warm container. For example, the first microservices M1 and the second microservices M2 may be executed sequentially in the same container, and the third microservices M3 and the fourth microservices M4 may be executed sequentially in the same container.

FIG. 5 is a diagram showing a process of executing a plurality of microservices in a training system according to an embodiment.

With reference to FIG. 5, a process of executing a training job when two processing units are allocated to the training job that requires four workers will be described.

According to an embodiment, the training job using four logical workers may be executed by the first processing unit 141 and the second processing unit 142. One processing unit may sequentially execute a plurality of microservices executed by two logical workers. Accordingly, in the same processing unit, a plurality of microservices may be executed in 2 phases during one-time iteration. For example, the first processing unit 141 may sequentially execute the first microservices M1 corresponding to the first logical worker LW1 and the second microservices M2 corresponding to the second logical worker LW2, and the first microservices M1 and the second microservices M2 may be executed in 2 phases during one-time iteration. For example, the second processing unit 142 may sequentially execute the third microservices M3 corresponding to the third logical worker LW3 and the fourth microservices M4 corresponding to the fourth logical worker LW4, and the third microservices M3 and the fourth microservices M4 may be executed in 2 phases during one-time iteration.

In detail, each of the plurality of processing units 141 and 142 may sequentially execute two computation functions C for processing a minibatch of the microservice during one-time iteration. For example, the first computation function C1-1 related to the first logical worker LW1 and the second computation function C2-1 related to the second logical worker LW2 may be sequentially executed through the first processing unit 141 during the first iteration (iteration 1). For example, the third computation function C3-1 related to the third logical worker LW3 and the fourth computation function C4-1 related to the fourth logical worker LW4 may be sequentially executed through the second processing unit 142 during the first iteration (iteration 1). According to an embodiment, the first computation function C1-1 and the second computation function C2-1 may be executed in the same container of the first processing unit 141 and the third computation function C3-1 and the fourth computation function C4-1 may be executed in the same container of the second processing unit 142, but is not limited thereto.

Similarly, the first computation function C1-2 and the second computation function C2-2 may be sequentially executed through the first processing unit 141 during the second iteration (iteration 2), and the third computation function C3-2 and the fourth computation function C4-2 may be sequentially executed through the second processing unit 142. The first computation function C1-3 and the second computation function C2-3 may be sequentially executed through the first processing unit 141 during the third iteration (iteration 3), and the third computation function C3-3 and the fourth computation function C4-3 may be sequentially executed through the second processing unit 142.

According to an embodiment, the first computation function C1-1 of the first logical worker LW1 executed by the first processing unit 141 and the third computation function C3-1 of the third logical worker LW3 executed by the second processing unit 142 may be executed in parallel with each other.

According to an embodiment, the computation functions C may compute a weight for each iteration, and the computed weight may be updated in the distributed in-memory database 260 (FIG. 10) through indirect communication. As described with reference to FIG. 3, in one iteration (e.g., iteration 1), each of the first aggregation function Agg1-1, the second aggregation function Agg2-1, the third aggregation function Agg3-1, and the fourth aggregation function Agg4-1 may aggregate the weight computed in the first computation function C1-1, the weight computed in second computation function C2-1, the weight computed in the third computation function C3-1, and the weight computed in the fourth computation function C4-1 to synchronize the weights. For example, the first aggregation function Agg1-1 may aggregate the weight computed in the first computation function C1-1, the weight computed in second computation function C2-1, the weight computed in the third computation function C3-1, and the weight computed in the fourth computation function C4-1 to update the global parameter. The first computation function C1-2, the second computation function C2-2, the third computation function C3-2, and the fourth computation function C4-2, which perform the subsequent iteration (iteration 2) may read the global parameter updated by the aggregation functions Agg1-1, Agg2-1, Agg3-1, and Agg4-1 and compute a new weight.

In a serverless environment, the computation functions C and the aggregation functions Agg may indirectly communicate with each other through a storage (e.g., the distributed in-memory database 260 of FIG. 10) and the storage may synchronize the weights via indirect communication. The aggregation functions Agg may be executed using a CPU resource alone. Although not limited, the aggregation functions Agg paired with a container for the computation functions C may be scheduled in the same node as the computation functions C. The training system according to an embodiment may be similar to AllReduce communication that performs model synchronization, but is not limited thereto.

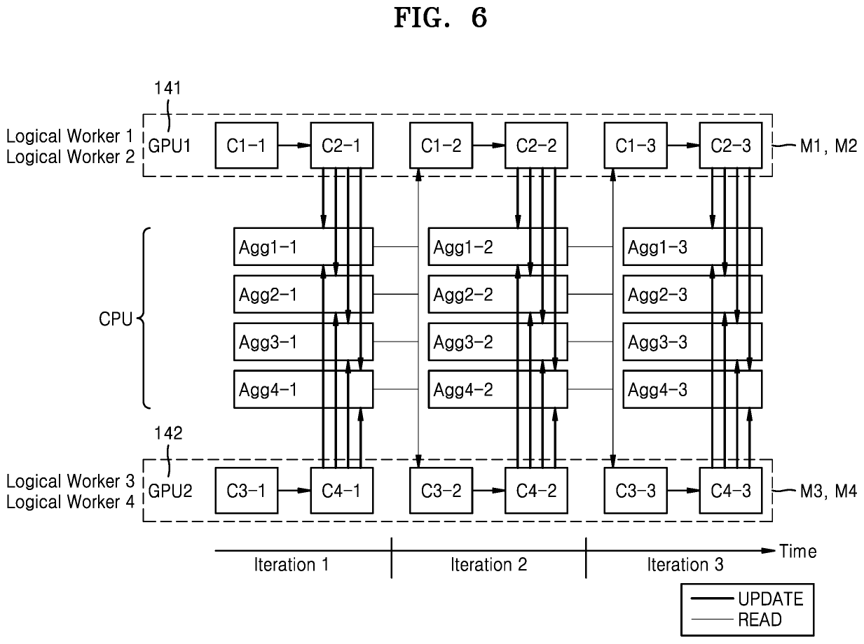

FIG. 6 is a diagram showing a process of executing a plurality of microservices through a processing unit in a training system according to an embodiment.

FIG. 6 illustrates an example of the case in which two processing units are allocated to a training job that requires four workers and a plurality of microservices are executed in two phases during each iteration in the same processing unit.

Referring to FIG. 6, in the training system 100 according to an embodiment, the computation functions C for computing weights and the aggregation functions Agg for aggregating the computed weights and synchronizing the global parameters may be executed at the same time. In the training system 100 according to an embodiment, one processing unit may execute multiple phases for each iteration, a computation function of a first phase alone among the multiple phases may read the global parameter, and computation functions of the other phases may use the global parameter read by the computation function of the first phase. In the training system according to an embodiment, a computation function of a last phase alone for each iteration may aggregate weights computed by computation functions of a previous phase to update the same in a distributed in-memory database. The aggregation function may read a copy of the weight updated in the distributed in-memory database. The training system 100 according to an embodiment may minimize communication overhead between the computation functions C and the aggregation functions Agg.

Hereinafter, the disclosure will be described in terms of a difference from the training system according to an embodiment of FIG. 5.

According to an embodiment, the computation functions C and the aggregation functions Agg may be executed in the same time. In FIG. 5, unlike the case in which the aggregation functions Agg are executed after the computation functions C are executed during one iteration, execution of the computation functions C and execution of the aggregation functions Agg may overlap each other.

For example, while the first the first computation function C1-1 and the second computation function C2-1 compute weights through the first processing unit 141, the first aggregation function Agg1-1, the second aggregation function Agg2-1, the third aggregation function Agg3-1, and the fourth aggregation function Agg4-1 may be executed in advance, and as soon as weight computation of each of the computation functions C is completed, the weights may be aggregated. For example, while the third computation function C3-1 and the fourth computation function C4-1 compute weights through the second processing unit 142, the first aggregation function Agg1-1, the second aggregation function Agg2-1, the third aggregation function Agg3-1, and the fourth aggregation function Agg4-1 may be executed in advance, and as soon as weight computation of each of the computation functions C is completed, the weights may be aggregated.

According to an embodiment, the computation function C of a first phase alone among the multiple phases may read the global parameter, and the computation functions C of the other phases may use the global parameter read by the computation function C of the first phase. The computation function C of the first phase among the multiple phases may transfer the global parameter to the computation functions C of the other phases. The computation functions C executed by the multiple phases are executed for the same iteration using the same container, and thus even if the computation function C of the first phase alone reads the global parameter, the computation functions C of the other phases may also obtain synchronized weights.

For example, in the second iteration (iteration 2), the first computation function C1-2 of the plurality of first microservices M1 and the second computation function C2-2 of the second microservices M2 may be executed in two phases as multiple phases. The first computation function C1-2 alone may read the global parameter from the first aggregation function Agg1-1, the second aggregation function Agg2-1, the third aggregation function Agg3-1, and the fourth aggregation function Agg4-1. The first computation function C1-2 may transfer the global parameter to the second computation function C2-2. The second computation function C2-2 is executed in the same container as the first computation function C1-2, and thus may use the global parameter read by the first computation function C1-2 and compute a weight.

According to embodiment, the computation functions C may read the global parameter stored in the distributed in-memory database 260 via indirect communication, and the first phase alone among the multiple phases may perform indirect communication to read the global parameter, thereby reducing communication overhead. For example, when a training job in which q logical workers are present is executed in p phases, the global parameter may be read q/p times through the distributed in-memory database 260 (p and q being a natural number). In FIG. 5, communication overhead may be reduced compared to the case in which computation functions in multiple phases read the global parameter q times.

According to an embodiment, the computation functions C of the multiple phases for each iteration may transfer the computed weights to the computation functions C of subsequent phases, respectively. The computation function C of the last phase may aggregate weights computed by the computation functions C of previous phases and update the weights in the distributed in-memory database. The aggregation function Agg may read a copy of the weight updated in the distributed in-memory database.

For example, in the second iteration (iteration 2), the first computation function C1-2 of the plurality of first microservices M1 may transfer the computed weight to the second computation function C2-2 of the second microservices M2. This is because the first computation function C1-2 and the second computation function C2-2 are executed in one iteration using the same container. The second computation function C2-2 may aggregate the weight received from the first computation function C1-2 and the weight computed by the second computation function C2-2. The second computation function C2-2 may update the aggregated weights in the distributed in-memory database. The first aggregation function Agg1-1, the second aggregation function Agg2-1, the third aggregation function Agg3-1, and the fourth aggregation function Agg4-1 may each read the updated weights.

According to embodiment, the computation functions C may update the weights in the distributed in-memory database 260 via indirect communication, and the last phase alone among the multiple phases may perform indirect communication to update the weights, thereby reducing communication overhead. For example, when a training job in which q logical workers are present is executed through p phases, the weights may be updated q/p times in the distributed in-memory database 260. In FIG. 5, communication overhead may be reduced compared to the case in which computation functions in multiple phases update the weights q times. The number of logical workers and the number of available processing units described above are not limited to the above-described examples.

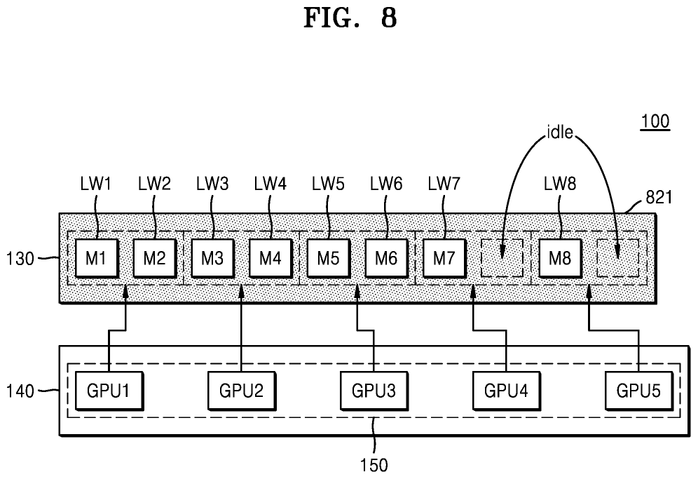

Hereinafter, a process of determining the number of processing units allocated to a training job will be described with reference to FIGS. 7 and 8.

FIGS. 7 and 8 show an example of a training job scheduled to a plurality of processing units in a training system according to an embodiment.

According to an embodiment, the training system 100 may submit the training job to the scheduler 130, and the scheduler 130 may add the submitted training job to a queue. The resource manager 150 may determine the number of resources to be allocated to the training job queuing in a queue, for example, the number of processing units. The resource manager 150 may allocate a predetermined number of processing units to the raining job.

For example, the resource manager 150 may allocate resources using a max-min fairness method in consideration of fairness. Alternatively, for example, the resource manager 150 may also allocate resources using a shortest-remaining-service-first (SRSF) method in consideration of efficiency. The scheduler 130 may schedule the allocated processing unit to a plurality of microservices belonging to the training job based on the availability status of the processing unit, that is, the number of the allocated processing units.

According to an embodiment, the resource manager 150 may allocate processing units, the number of which is equal to or less than the number of workers required to execute a training job. When the number of the allocated processing units is equal to the number of required workers, the scheduler 130 may schedule the processing unit to execute a plurality of microservices in a single phase. When the number of the allocated processing units is less than the number of required workers, the scheduler 130 may schedule the processing unit to sequentially execute a plurality of microservices in multiple phases. According to an embodiment, some of a plurality of processing units belonging to a training job may be executed in p phases by any one processing unit. Here, p phases may be a single phase or multiple phases (p being a natural number).

According to an embodiment, the training system 100 may allocate the processing unit in units of 2ⁿ to the training job (n being 0 or a natural number). For example, when 2ⁿ workers are needed for any one training job to perform training, the resource manager 150 may allocate processing units in units of 2ⁿ. For example, when the training job has 2ⁿ microservices that are individually executed by 2ⁿ logical workers, the resource manager 150 may allocate as many processing units as a divisor of 2ⁿ to the corresponding training job. The scheduler 130 may schedule processing units, the number of which is a divisor of 2ⁿ and which is allocated to the corresponding training job, to a plurality of microservices.

FIG. 7 illustrates an example in which eight workers are needed to perform training by a training job 721 (e.g., n=3). In this case, any one training job 721 may have eight logical workers, and the resource manager 150 may allocate processing units, the number of which is a divisor of 8 (i.e., 1, 2, 4, or 8), to 8 logical workers. The resource manager 150 may allocate processing units, the number of which is equal to or less than the number of the eight logical workers. For example, when the number of logical workers and the number of the allocated processing units are the same, the scheduler 130 may schedule processing units in one-to-one correspondence to a plurality of microservices corresponding to respective logical workers. In this case, each of the plurality of microservices may be executed in a single phase (e.g., p=1). Alternatively, for example, when the number of allocated processing units is less than the number of logical workers, the scheduler 130 may schedule a plurality of microservices corresponding to a plurality of logical workers to at least one processing unit, and the plurality of microservices may be executed in multiple phases by at least one processing unit (e.g., p>1).

FIG. 7 shows an example in which four processing units (e.g., GPU1, GPU2, GPU3, and GPU4) are allocated to the training job 721 that requires eight workers. The resource manager 150 may allocate the four processing units (GPU1, GPU2, GPU3, and GPU4) to the training job 721. In this case, the scheduler 130 may schedule two logical workers to one processing unit, and thus a plurality of microservices corresponding to a plurality of logical workers may be executed sequentially in two phases (e.g., p=2). A chain of eight microservices corresponding to the training job 721 may be executed in two phases using four processing units.

In more detail, the training job 721 may include the first logical worker LW1, the second logical worker LW2, the third logical worker LW3, the fourth logical worker LW4, a fifth logical worker LW5, a sixth logical worker LW6, a seventh logical worker LW7, and an eighth logical worker LW8. In other words, the training includes eight logical workers, and eight workers may be needed to execute the training job. The first logical worker LW1, the second logical worker LW2, the third logical worker LW3, the fourth logical worker LW4, the fifth logical worker LW5, the sixth logical worker LW6, the seventh logical worker LW7, and the eighth logical worker LW8 may correspond to the plurality of first microservices M1, the plurality of second microservices M2, the plurality of third microservices M3, the plurality of fourth microservices M4, a plurality of fifth microservices M5, a plurality of sixth microservices M6, a plurality of seventh microservices M7, and a plurality of eighth microservices M8, respectively.

A plurality of processing units GPU1, GPU2, GPU3, and GPU4 may be scheduled to the plurality of logical workers LW1, LW2, LW3, LW4, LW5, LW6, LW7, and LW8. For example, 4 processing units, which are one of divisors of 8, may be scheduled to the plurality of logical workers LW1, LW2, LW3, LW4, LW5, LW6, LW7, and LW8. For example, a first processing unit GPU1 may be scheduled to the first logical worker LW1 and the second logical worker LW2, a second processing unit GPU2 may be scheduled to the third logical worker LW3 and the fourth logical worker LW4, a third processing unit GPU3 may be scheduled to the fifth logical worker LW5 and the sixth logical worker LW6, and a fourth processing unit GPU4 may be scheduled to the seventh logical worker LW7 and the eighth logical worker LW8. In this case, the plurality of first microservices M1 corresponding to the first logical worker LW1 and the plurality of second microservices M2 corresponding to the second logical worker LW2 may be sequentially executed in two phases through the first processing unit GPU1. The plurality of third microservices M3 corresponding to the third logical worker LW3 and the plurality of fourth microservices M4 corresponding to the fourth logical worker LW4 may be sequentially executed in two phases through the second processing unit GPU2. The description of the plurality of fifth microservices M5, the plurality of sixth microservices M6, a plurality of seventh microservices M7, and a plurality of eighth microservices M8 is the same as the description of the plurality of first microservices M1 and the plurality of second microservices M2 and thus will be omitted.

FIG. 8 shows an example of the case in which processing units, the number of which is not units of 2ⁿ, are allocated to the training job 821 that requires workers in units of 2ⁿ. That is, the drawing shows an example in which processing units, the number of which is not a divisor of 2ⁿ, are allocated to the training job 821. In this case, the number of microservices that need to be processed by at least one processing unit may be different from the number of microservices that need to be processed by other processing units, respectively. For example, an execution time of a processing unit that executes microservices in a single phase may be less than an execution time of a processing unit that executes microservices in multiple phases. In this case, at least one processing unit may be in idle state until other processing units complete an iteration. The idle state means a state in which a processing unit is not used by any program. When there is a processing unit in an idle state, the efficiency of resource allocation may be reduced.

In more detail, five processing units (e.g., GPU1, GPU2, GPU3, GPU4, and GPU5) are allocated to the training job 821 that requires eight workers. The resource manager 150 may allocate the five processing units (e.g., GPU1, GPU2, GPU3, GPU4, and GPU5) to the training job 821. In this case, the fourth processing unit GPU4 may be allocated to the seventh logical worker LW7, and the fifth processing unit GPU5 may be allocated to the eighth logical worker LW8. The fourth processing unit GPU4 and the fifth processing unit GPU5 may each execute microservices in a single phase. An execution time of each of the fourth processing unit GPU4 and the fifth processing unit GPU5 may be in an idle state until other processing units (e.g., GPU1, GPU2, and GPU3) complete an iteration according to multiple phases.

Thus, according to an embodiment, the training system 100 may allocate and schedule processing units, the number of which is units of 2ⁿ, to a training job including 2ⁿ logical workers. The training system 100 may minimize resource allocation while optimizing performance when allocating processing units, the number of which is a divisor of 2ⁿ as shown in FIG. 7. According to an embodiment, when a training job corresponding to a neural network model does not include logical workers, the number of which is units of 2ⁿ, the training system 100 may also differently determine the number of processing units allocated to the corresponding training job.

For example, the training job may include 2k (k being a natural number) logical workers. The scheduler 130 of the training system 100 may allocate a plurality of processing units in units of any one of divisors of 2k when the training job includes 2k logical workers. For example, when the training job include six logical workers, the scheduler 130 may allocate a plurality of processing units in units of any one of 1, 2, 3, and 6. Accordingly, in one processing unit, the logical worker may be executed in p phases (p being a natural number).

For example, the training job may include 2k−1 (k being a natural number) logical workers. The scheduler 130 of the training system 100 may allocate a plurality of processing units in units of any one of divisors of 2k−1 or divisors of 2k, except for 1 and 2k when the training job includes 2k−1 logical workers. For example, when the training job includes nine logical workers, the scheduler 130 may allocate a plurality of processing units in units of any one of 1, 3, and 9, which is a divisor of 9, or may allocate the plurality of processing units in units of any one of 2 and 5 of a divisor of 10, except for 1 and 10. Accordingly, in one processing unit, the logical worker may be executed in p phases. When the scheduler 130 allocates a plurality of processing units, the number of which is units of 2 or 5 as any one of divisors of 2k, to the logical worker, a processing unit in an idle state may be generated as shown in FIG. 8.

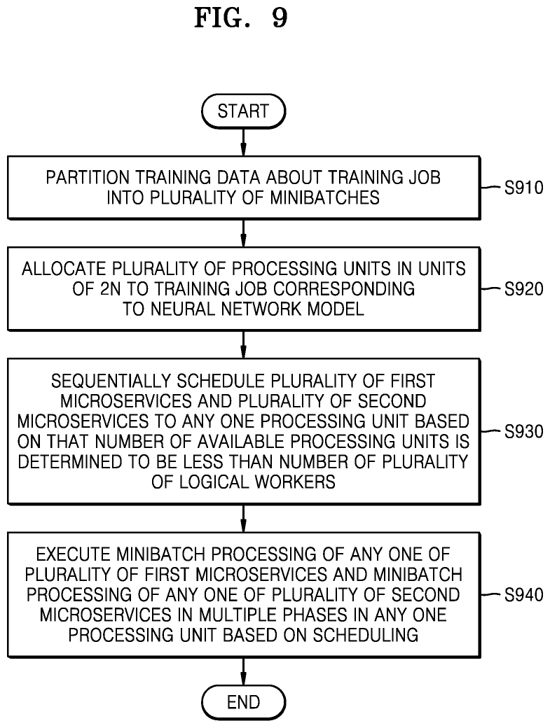

FIG. 9 is a flowchart illustrating an operating method of a training system according to an embodiment.

Referring to FIG. 9, in operation S910, the training system 100 may partition training data for the training job 120 into a plurality of minibatches. A plurality of microservices may include a function that processes a plurality of minibatches. For example, 200 training data may be partitioned into 32 units, and each partitioned unit may correspond to a minibatch.

For example, a plurality of microservices may include a chain of the computation functions C that process a plurality of minibatches, respectively, through a forward pass and a backward pass for the plurality of minibatches and compute weights for the plurality of minibatches, respectively. The weights of the plurality of respective minibatches may be aggregated by the aggregation functions Agg of the plurality of microservices and synchronized with each other.

In operation S920, the training system 100 may allocate a plurality of processing units in units of 2ⁿ to a training job corresponding to a neural network model. For example, when logical workers in units of 2ⁿ are needed to perform a training job, the resource manager 150 may allocate processing units, the number of which is a divisor of 2ⁿ. Operation S920 may be performed by a resource manager 226 to be described below with reference to FIG. 10.

In operation S930, based on that the number of available processing units is determined to be less than the number of a plurality of logical workers, the training system 100 may sequentially schedule a plurality of first microservices and a plurality of second microservices to any one processing unit. The scheduler 130 may schedule a first type of microservice among the plurality of first microservices and a first type of microservice among the plurality of second microservices to be sequentially executed in the same iteration. While including a plurality of third microservices executed by a third logical worker among a plurality of logical workers and a plurality of fourth microservices executed by a fourth logical worker among the plurality of logical workers, the scheduler 130 may schedule the plurality of third microservices and the plurality of fourth microservices to be sequentially executed in another processing unit among a plurality of processing units.

According to an embodiment, the scheduler 130 may schedule the plurality of first microservices and the plurality of second microservices to the same container.

According to an embodiment, the scheduler 130 may reschedule a plurality of microservices to a plurality of processing units based on overhead due to cold start of a container, locality between the plurality of microservices, or performance interference between the plurality of microservices.

According to an embodiment, the scheduler 130 may schedule minibatch processing of any one of the plurality of first microservices and minibatch processing of any one of the plurality of second microservices to be executed in multiple phases in any one processing unit. For example, the scheduler 130 may schedule the first computation function C1-1 for processing a minibatch of any one of the plurality of first microservices M1 and the second computation function C2-1 for processing a minibatch of any one of the plurality of second microservices M2 to be executed in multiple phases (refer to FIG. 5).

In operation S940, the training system 100 may perform minibatch processing of any one of the plurality of first microservices and minibatch processing of any one of the plurality of second microservices in multiple phases in any one processing unit based on scheduling. For example, referring to FIG. 5, the first computation function C1-1 for processing a minibatch of any one of the plurality of first microservices M1 and the second computation function C2-1 for processing a minibatch of any one of the plurality of second microservices M2 may be sequentially executed in multiple phases during a first iteration (iteration 1).

Minibatch processing of the plurality of third microservices M3 and minibatch processing of the plurality of first microservices M1 may be executed in parallel.

FIG. 10 is a diagram showing the configuration of a training system according to an embodiment.

Referring to FIG. 10, a training system 200 according to an embodiment may include, for example, a job proxy 210, a controller 220, a fault handler 230, and an action database 240. The training system 200 may further include a distributed file system 250 and a distributed in-memory database 260. “Whale icon” shown in FIG. 10 may mean, for example, a container such as Docker.

The training system 200 partitions a training job into a plurality of microservices to be executed by a logical worker of a neural network model. The training system 200 trains the neural network model by scheduling a neural network model of a plurality of microservices to a heterogeneous graphic processing unit included in each of a plurality of clusters. To this end, an operation of each component of the training system 200 will be described below.

The job proxy 210 may perform pre-processing on training data for training of the neural network model. Here, pre-processing may mean, for example, that the training data is partitioned into units of microservice functions. The job proxy 210 may generate an initial weight to be used by a plurality of logical workers for the pre-processed training data and store the initial weight in the distributed file system 250. The job proxy 210 may partition the training job into a plurality of microservices according to a type of computation (e.g., computation function or aggregation function) for the pre-processed training data. The job proxy 210 may convert the training job into a chain of the microservices.

The job proxy 210 may include an input manager 213 and a job manager 216.

The input manager 213 may process the training data in the form corresponding to a plurality of microservices. The input manager 213 may, for example, partition the training data for each minibatch or partition the training data in units of microservices.

The job manager 216 may classify the partitioned plurality of microservices into, a first type of microservices for computing parameters (or weights) and a second type of microservices for aggregating the parameters. In addition, the job manager 216 may transfer information about the classified plurality of microservices to a scheduler 223. For example, the job manager 216 may transfer information required for scheduling, including a computation type of the classified plurality of microservices (e.g., computation of parameters or aggregation of parameters), information on a minibatch to be executed, and the number of iterations, to the scheduler 223.

As described above, the plurality of logical workers may train the training data allocated thereto. At this time, a final parameter obtained by completing a training process may be stored in the distributed file system 250, for example. Intermediate data such as a parameter, gradient, and active output of a neural network model locally computed during the training process, or globally shared during the training process may be stored in the in-memory database 260. Parameters may be shared among logical workers through continued iterations of the training process, and there may be a variety of policies that synchronize the parameters.

The job manager 216 may classify a plurality of microservices according to a computation type based on a synchronization policy for parameters. Examples of policies for synchronizing parameters may include an asynchronous parallel (ASP) model and a stale synchronous parallel (SSP) model in addition to a bulk synchronous parallel (BSP) model illustrated in FIG. 2. The BSP model may use barrier synchronization and a logical worker that reaches a barrier waits for all other logical workers to reach the barrier, and thus synchronization may be performed together in all the logical workers. According to an embodiment, a synchronization policy such as the aforementioned BSP, ASP, or SSP model may be dynamically changed according to a situation of a resource or the characteristics of a neural network model to perform training of the neural network model.

The job manager 216 may transfer information about the classified plurality of microservices to the scheduler 223 based on the synchronization policy for the parameters generated by training. For example, a value for a parameter of the neural network model may be computed whenever each minibatch is processed. When these minibatches are executed by multiple virtual workers, values of parameters need to aggregated according to the synchronization policy. The job manager 216 may generate a microservice that performs the aggregation work according to the synchronization policy and transfer the microservice to the scheduler 223.

The controller 220 may schedule a plurality of microservices partitioned by the job proxy 210 to a heterogeneous graphic processing unit and perform resource management such as resource allocation according to scheduling.

The controller 220 may include, for example, a scheduler 223 and a resource manager 226. The scheduler 223 may correspond to the scheduler 130 of FIG. 1, and the resource manager 226 may correspond to the resource manager 150 of FIG. 7.

The scheduler 223 may schedule a plurality of microservices to a plurality of graphics processing units contained in a cluster. The scheduler 223 may dynamically allocate a plurality of microservices to a plurality of graphics processing units based on the availability status of the graphic processing unit. For example, in consideration of a resource situation of the cluster, when the number of processing units in an availability status is less than the number of logical workers required to execute the training job, the scheduler 223 may schedule the plurality of microservices to the same processing unit. In other words, the scheduler 223 may allocate resources, the number of which is less than the number of logical workers required for training of a neural network model, thereby increasing the elasticity of resource utilization. When a resource is allocated through the scheduler 223, a hyper-parameter, such as the number of workers or a size of local batch, is not changed, and thus a convergence behavior may be maintained.

The scheduler 223 may schedule a processing unit to a plurality of microservices based on the overhead, locality and performance interference due to cold start of a container.

For example, the scheduler 223 may schedule the plurality of microservices to execute the plurality of microservices in the same container. The scheduler 223 may minimize the overhead due to cold start of a container by scheduling a plurality of microservices to the same container. When the microservices are called, a time for the “cold start”, which is an operation of initializing the container before executing the microservices, may be consumed, and communication overhead due to cold start may be generated. According to an embodiment, the scheduler 223 may reuse the same container to execute at least two microservices (e.g., the first computation function C1-1 and the second computation function C2-1 of FIG. 5) and thus may use the container in a warm container state. Thus, the initialization operation of the container is omitted before the microservices are executed, and thus the overhead due to cold start may be minimized.

For example, the scheduler 223 may consider the locality of the container used to execute the microservices of the training job. Locality between microservices may correspond to a distance between intermediate data used by the microservices, respectively, for example. The scheduler 223 may schedule the microservices in consideration of the location of the intermediate data to be used by the microservices stored in the distributed in-memory database 260 and the location of a GPU in which the microservices are to be executed. The scheduler 223 may schedule a training job sensitive to locality to be executed using a minimum number of nodes. For example, when the first scheduled container is far away and locality is poor, if a node having better locality turns into an availability status, the scheduler 223 may reschedule a container for the microservice. Thus, the scheduler 223 may improve the locality between a plurality of microservices.

For example, the scheduler 223 may minimize interference between microservices. For example, when one node is set with multicores and multi GPUs, a plurality of microservices may be executed at the same time in one node. Interference between microservices means that performance is lowered due to a limitation of a physical resource of a node based on contention with a serverless function of another user, which is executed in one node in a shared cluster environment. When the performance of the first scheduled node is lowered, the scheduler 223 may reschedule the microservices to another node changed to an availability status. Thus, the scheduler 223 may minimize interference between microservices and improve performance.

The resource manager 226 may adjust the number of the plurality of processing units allocated according to scheduling of the scheduler 223. For example, the resource manager 226 may determine which cluster is allocated to the training job and how many processing units are allocated. For example, when the number of logical workers is a unit of 2ⁿ, the resource manager 226 may determine to allocate processing units in units of divisors of 2ⁿ.

According to an embodiment, the resource manager 226 may allocate resources using a max-min fairness method. For example, resource allocation may be fairly performed by ensuring 1/m of resources through the max-min fairness method. Here, m may be the number of training jobs submitted to the cluster. Therefore, when the resource manager 226 allocates resources in units of 2ⁿ to each of m training jobs, the resource manager 226 may allocate more processing units to the training job that is first submitted among training jobs that require the same number of processing units.

The resource manager 226 according to an embodiment may allocate resources using a shortest-remaining-service-first (SRSF) method. The SRSF method may be referred to as a shortest-remaining-service-first scheduling method. The SRSF method is a GPU scheduling method considering efficiency, which refers to a scheduling method in which a training job with the shortest remaining service time is first executed. The remaining time of the training job may mean a time left until the training job is completed, that is, a remaining execution time. The remaining service time of the training job may be computed by multiplying the remaining execution time of the corresponding training job with the number of GPUs needed to execute the corresponding training job. For example, the resource manager 226 may align m training jobs in descending order of remaining service time and allocate processing units in the order starting from the training job with the shortest remaining service time. m may be the number of training jobs submitted to the cluster.

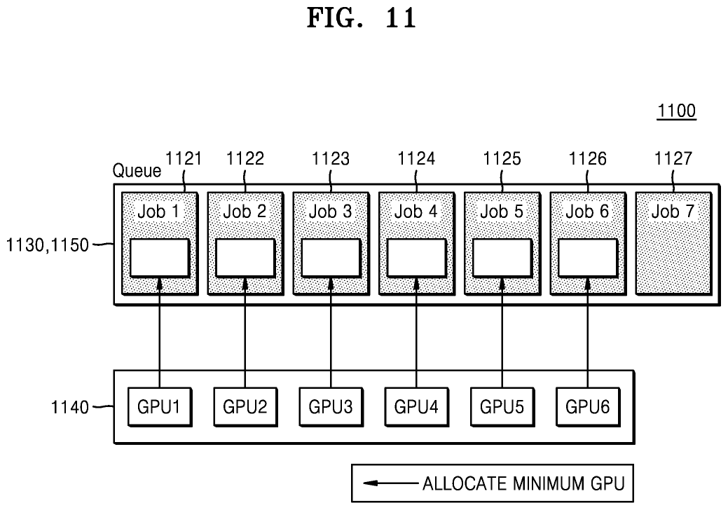

The SRSF method may be similar to a shortest-remaining-time-scheduling (SRT scheduling) method or a shortest-job-first-scheduling (SJF scheduling) method as one of general CPU scheduling methods. According to an embodiment, the resource manager 226 may use a resource allocation method considering fairness and efficiency at the same time, in consideration of both the max-min fairness and the SRSF method. This will be explained in detail below with reference to FIG. 11 and subsequent diagrams.

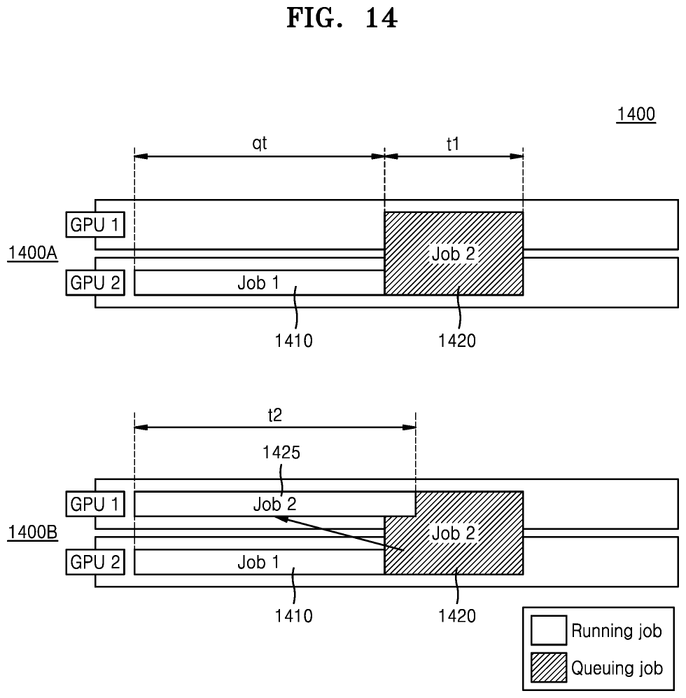

The resource manager 226 according to an embodiment may reallocate resources when there is a queuing training job stored in a queue. For example, when the queuing time of the queuing training job is longer than an expected increase time when one or more training jobs are executed in multiple phases, the resource manager 226 may reallocate processing units to the queuing training job. This will be described with reference to FIGS. 14 to 16.

The resource manager 226 according to an embodiment may use a priority based policy, a deadline-aware policy, a heterogeneity-aware policy, and the like and apply various technologies used in managing common resource-sharing clusters, such as dominant resource fairness (DRF) or two-level hierarchy Hadoop fair scheduler.

A fault handler 230 may detect microservices in which a fault occurs among a plurality of microservices and perform an operation of the detected microservice again.

An action database 240 may store an action, which are execution units obtained by dividing the existing monolithic training job into small function units of a microservice. The action may be some operations of forward pass and backward pass processes or a process of processing parameters.

The distributed file system 250 may store permanent data, for example, training data for training and a final parameter after training ends. The training data may be, for example, the training data received from a user by the input manager 213. The distributed file system 250 may be, for example, a Hadoop distributed file system (HDFS).

The distributed in-memory database 260 may store intermediate data such as a gradient that is locally calculated during a training process, for example. For example, the distributed in-memory database 260 may store the weights generated by execution of a plurality of microservices for indirect communication between a plurality of microservices. For example, the distributed in-memory database 260 may store the weights generated by execution of a computation function. For example, the distributed in-memory database 260 may store the global parameters that are weights aggregated by execution of the aggregation function. For example, the computation function executed in a subsequent iteration may read the global parameter stored in the in-memory database 260. For example, the computation function may transfer weights through the aggregation function and the distributed in-memory database 260.

The distributed in-memory database 260 may be implemented, for example by a redis cluster that is a simple map data storage in which a key and a value are mapped to each other. The redis cluster may be a high-performance key-value storage, for example, NoSQL that supports various forms of data structures such as lists, hashes, and sorted sets. The redis cluster may be used mainly as a cache solution of a relational database management system (RDBMS), residing in different clusters or memories of processing units of the different clusters.

Hereinafter, the case in which a plurality of training Jobs are submitted to a training system 1100 according to an embodiment will be described with reference to FIGS. 11 to 13.

FIG. 11 shows an example of a process of allocating processing units to a plurality of training jobs in a training system according to an embodiment.

With reference to FIG. 11, the case in which seven training jobs are submitted to the training system 1100 according to an embodiment and six GPU resources are present in a cluster 1140 will be described.

A plurality of training jobs may be submitted to the training system 1100 according to an embodiment. The plurality of training jobs may include first to seventh training jobs 1121, 1122, 1123, 1124, 1125, 1126, and 1127. The plurality of training jobs may correspond to different neural network models, respectively. Each of the plurality of training jobs may be partitioned into a plurality of microservices, like the training job 120 of FIG. 1, and may be executed by one or more logical workers.

The training system 1100 according to an embodiment may submit the first to seventh training jobs 1121, 1122, 1123, 1124, 1125, 1126, and 1127 to a controller. The controller may include a scheduler 1130 and a resource manager 1150. The scheduler 1130 may add the plurality of training jobs to a queue of the scheduler 1130. The plurality of training jobs may queue in the queue.

The training system 1100 according to an embodiment may align the plurality of training jobs in the order of remaining service time using an SRSF method. The remaining service time of the training job may be computed by multiplying the remaining execution time of the corresponding training job with the number of processing units needed to execute the corresponding training job. For example, the training system 1100 may compute the remaining service time for each of the plurality of training jobs and align the plurality of training jobs in descending order of remaining service time based on the computed remaining service time.

For example, the remaining service time may increase from the first training job 1121 to the seventh training job 1127. The first training job 1121 has a shortest remaining service time, and thus when a processing unit is allocated first to the first training job 1121, the work may be completed within the shortest time. For example, the seventh training Job 1127 may have the longest remaining service time. The training system 1100 may allocate priorities for allocating processing units in the order from the first training job 1121 to the seventh training job 1127. The first training job 1121 to the seventh training job 1127 may be aligned in the queue in the order from the first training job 1121 to the seventh training job 1127.

The training system 1100 according to an embodiment may use a resource allocation method considering the max-min fairness and the SRSF method at the same time. The training system 1100 may allocate a minimum number of processing units to ensure 1/m of resources as much as possible using the max-min fairness method. The training system 1100 may allocate a minimum number of processing units in order from a training job with the shortest remaining service time using the max-min fairness and the SRSF method. Thus, the training system 1100 may allocate processing units to as many training jobs as possible. m may be the number of training jobs submitted to the training system 1100.

For example, the training system 1100 may allocate one processing unit to each of the plurality of training jobs to ensure 1/7 of resources in the plurality of training jobs. For example, when there are six processing units in the cluster 1140, the minimum number of processing units may be 1. The training system 1100 may first allocate one processing unit (e.g., GPU1) to the first training job 1121 with the shortest remaining service time. The training system 1100 may allocate processing units one by one in the order of the second training job 1122, the third training job 1123, the fourth training job 1124, the fifth training job 1125, and the sixth training job 1126. When there is no remaining processing unit in the cluster 1140, the training system 1100 may not allocate processing units to the seventh training job 1127 with the longest remaining service time. For example, six processing units GPU1, GPU2, GPU3, GPU4, GPU5, and GPU6 present in the cluster 1140 may be fairly allocated with the same number to six training jobs. The cluster 1140 may not have a left processing unit, that is, the remaining processing unit.

The training system 1100 according to an embodiment may use the max-min fairness method and thus may fairly allocate resources to the maximum amount of training jobs. The training system 1100 may use the SRSF method and thus may efficiently allocate resources to rapidly train training jobs with the shortest processing time. According to an embodiment, an average job completion time (average JCT) of the plurality of training jobs submitted to the training system 1100 may be minimized. The average JCT may be computed by averaging times for which training of the plurality of training jobs are completed.

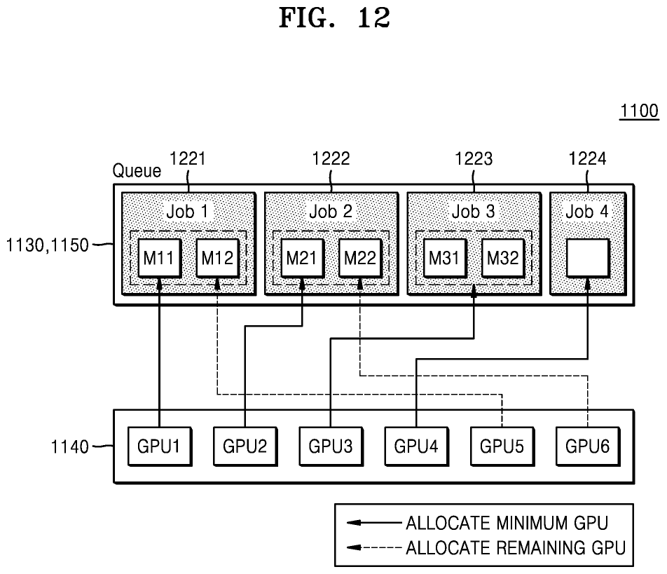

FIG. 12 shows an example of a process of allocating processing units to a plurality of training jobs in a training system according to an embodiment.

With reference to FIG. 12, the case in which four training jobs are submitted to the training system 1100 according to an embodiment and six GPU resources are present in a cluster 1140 will be described.

A plurality of training jobs may be submitted to the training system 1100 according to an embodiment. The plurality of training jobs may include first to fourth training jobs 1221, 1222, 1223, and 1224. The plurality of training jobs may correspond to different neural network models, respectively. Each of the plurality of training jobs may be partitioned into a plurality of microservices, like the training job 120 of FIG. 1, and may be executed by one or more logical workers.

For example, the first training job 1221 may be executed by two logical workers. Two processing units may be required to execute the first training job 1221. The first training job 1221 may include two microservices M11 and M12 executed by two logical workers. For example, the second training job 1222 may include two microservices M21 and M22 executed by two logical workers. For example, the third training job 1223 may include two microservices M31 and M32 executed by two logical workers. The fourth training job 1224 may be executed by one or more logical workers.

The training system 1100 according to an embodiment may submit the first to fourth training jobs 1221, 1222, 1223, and 1224 to a controller, like in FIG. 11. The scheduler 1130 may add the plurality of training jobs to a queue of the scheduler 1130. The plurality of training jobs may queue in the queue.

The training system 1100 according to an embodiment may align the plurality of training jobs in the order of remaining service time using an SRSF method. For example, the remaining service time may increase from the first training job 1221 to the fourth training job 1224. The training system 1100 may allocate priorities for allocating processing units in the order from the first training job 1221 to the fourth training job 1224. The first training job 1221 to the fourth training job 1224 may be aligned in the order from the first training job 1221 to the fourth training job 1224 in the queue of the scheduler 1130.

The training system 1100 according to an embodiment may use a resource allocation method considering the max-min fairness and the SRSF method at the same time, like in FIG. 11. For example, the training system 1100 may allocate one processing unit to each of the plurality of training jobs to ensure ¼ of resources in the plurality of training jobs. For example, when there are six processing units in the cluster 1140, the minimum number of processing units may be 1. The training system 1100 may first allocate one processing unit (e.g., GPU1) to the first training job 1221 with the shortest remaining service time. The training system 1100 may allocate processing units one by one in the order of the second training job 1222, the third training job 1223, and the fourth training job 1224.

The training system 1100 according to an embodiment may allocate the remaining processing units using the SRSF method when the remaining processing unit is present in the cluster 1140. As the training system 1100 allocates a minimum number of processing units to the maximum number of training jobs, there may be remaining processing units in the cluster 1140. The remaining processing unit may mean the processing unit remaining in the cluster 1140 after processing units are fairly allocated to each of the plurality of training jobs. The training system 1100 may further allocate the remaining processing units in the order from a training job with the shortest remaining service time. For example, two processing units (e.g., GPU5 and GPU6) may remain in the cluster 1140. The training system 1100 may allocate the remaining processing units in the order from the first training job 1221 to the fourth training job 1224.

The training system 1100 according to an embodiment may allocate the remaining processing unit to the training job, to which less resources than required resources are allocated, in the order from the training job with the shortest remaining service time. The number of resources needed for each training job may correspond to the number of logical workers to execute microservices belonging to each training job. For example, when one processing unit (e.g., GPU1) is allocated to the first training job 1221, or when one processing unit (e.g., GPU2) is allocated to the second training job 1222, the number of allocated processing units may be less than the number of required resources. The training system 1100 may further allocate the remaining processing unit (e.g., GPU5) to the first training job 1221 and further allocate the remaining processing unit (e.g., GPU6) to the second training job 1222. Accordingly, two processing units may be allocated to each of the first training job 1221 and the second training job 1222, and one processing unit may be allocated to each of the third training job 1223 and the fourth training job 1224.

In the training system 1100 according to an embodiment, the number of phases in which the training job, to which the remaining processing unit is further allocated, is executed in the same processing unit may be reduced. For example, when one processing unit (e.g., GPU1) is allocated to the first training job 1221, the first training job 1221 may be executed in two phases (phase 2) in GPU1. For example, when two processing units (e.g., GPU1 and GPU5) are allocated to the first training job 1221, the first training job 1221 may be executed in one phase in GPU1 and one phase in GPU5.

The training system 1100 according to an embodiment may repeatedly perform a process of allocating remaining processing units until all processing units equal to the number of resources required for each training job are allocated. The training system 1100 may further allocate the remaining processing units to the training job that is executed in multiple phases to complete the training job executed in multiple phases as rapidly as possible. The training system 1100 may execute the training job in less phases or a single phase by further allocating the remaining processing unit to the training job executed in multiple phases.

The training system 1100 according to an embodiment may repeatedly perform the process of allocating the remaining processing units to each training job until the remaining processing unit is not present in the cluster 1140. For example, when there is no remaining processing unit in the cluster 1140 after the remaining processing units are allocated to the first training job 1221 and the second training job 1222, the remaining processing unit may not be allocated to the third training job 1223 and the fourth training job 1224. In this case, one processing unit (e.g., GPU3) may be allocated to the third training job 1223, and the third training job 1223 may be executed in two phases in GPU3.

The training system 1100 according to an embodiment may train quickly as many training jobs as possible by increasing the amount of allocated resources for training jobs that have a short remaining service time and are executed in multiple phases.

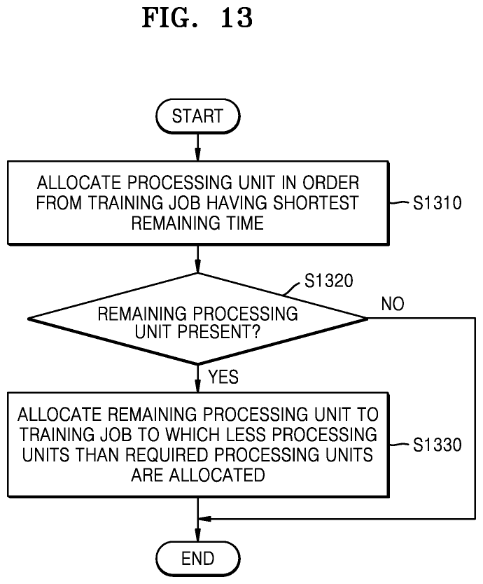

FIG. 13 is a flowchart of a method of allocating processing units to a plurality of training jobs in a training system according to an embodiment.

Referring to FIG. 13, in S1310, the training system 1100 may allocate processing units present in the cluster 1140 in the order from a training job with the shortest remaining service time. Thus, the training system 1100 may allocate a minimum number of processing units to as many training jobs as possible. The training system 1100 may use a resource allocation method considering the max-min fairness and the SRSF method at the same time.

The training system 1100 may align the plurality of training jobs in the order of remaining service time using an SRSF method. For example, the training system 1100 may compute the remaining service time for each of the plurality of training jobs and align the plurality of training jobs in descending order of remaining service time based on the computed remaining service time. The training system 1100 may allocate priority to allocate processing units to a training job with a short remaining service time.

The training system 1100 may allocate a minimum number of processing units to ensure 1/m of resources as much as possible in each of a plurality of training jobs using a max-min fairness method. The training system 1100 may allocate a minimum number of processing units in the order from a training job with the shortest remaining service time using the max-min fairness and the SRSF method.

In operation S1320, the training system 1100 may identify whether the remaining processing unit is present in the cluster 1140. The remaining processing unit may mean the processing unit remaining in the cluster 1140 after processing units are fairly allocated to each of the plurality of training jobs.

As the training system 1100 allocates processing units to a plurality of training jobs using the max-min fairness method, remaining processing units may or may not be present in cluster 1140. For example, there may be no remaining processing unit in the cluster 1140, like in FIG. 11. For example, there may be no remaining processing unit in the cluster 1140, like in FIG. 12.

When there is no remaining processing unit in the cluster 1140, the training system 1100 may complete an operation of allocating the processing units. For example, the training system 1100 may schedule the processing units allocated to each training job, through the scheduler 1130.

In operation S1330, as the remaining processing unit is present in the cluster 1140, the training system 1100 may allocate the remaining processing unit to a training job, to which less processing units than required processing units are allocated. The training system 1100 may allocate the remaining processing unit to the training job, to which less processing units than required processing units are allocated, in the order from the training job with the shortest remaining service time.

According to an embodiment, the remaining processing units corresponding to the number of processing units required for the corresponding training job may be further allocated to a training job to which less processing units than the required processing units are allocated. The number of phases in which the training job with the remaining processing unit is further allocated thereto is executed in the same processing unit may decrease. For example, when less processing units than processing units required for a training job are allocated, the training job may be executed in multiple phases. When the remaining processing unit is further allocated to the training job, the same processing unit may execute less phases than the multiple phases or a single phase.

The training system 1100 according to an embodiment may repeatedly perform a process of allocating remaining processing units until all processing units equal to the number of resources required for each training job are allocated. The training system 1100 may further allocate more remaining processing units to a training job executed in multiple phases and thus execute the training job in less phases or a single phase.

The training system 1100 according to an embodiment may repeatedly perform the process of allocating the remaining processing units to the training job until the remaining processing unit is not present in the cluster 1140.

The training system 1100 according to an embodiment may train quickly as many training jobs as possible by increasing the amount of allocated resources for training jobs that have a short remaining service time and are executed in multiple phases.

Hereinafter, the case in which a plurality of training Jobs are submitted to a training system 1400 according to an embodiment will be described with reference to FIGS. 14 to 16.

FIG. 14 shows an example of a process of allocating processing units to a plurality of training jobs in a training system according to an embodiment.

With reference to FIG. 14, an example of the case in which two training jobs 1410 and 1420 are submitted to the training system 1400 according to an embodiment and two GPU resources (GPU1 and GPU2) are present in a cluster will be described.

The training system 1400 according to an embodiment may allocate resources using the SRSF method. For example, the remaining service time of a first training job 1410 may be less than the remaining service time of a second training job 1420.

Referring to 1400A, the training system 1400 may preferentially allocate as many resources (e.g., one GPU) that are required for the first training job 1410. The second training job 1420 may queue in a queue of a scheduler. In the disclosure, the second training job 1420 queuing in the queue may be referred to as a queuing training job.

The training system 1400 according to an embodiment may allocate resources to minimize an average JCT. For example, a first method in which less processing units than processing units required for each of the plurality of training jobs are allocated and the plurality of training jobs are each executed in multiple phases may minimize the average JCT. For example, a second method in which processing units required for each of the plurality of training jobs are allocated and the plurality of training jobs are each executed in a single phase may minimize the average JCT. The training system 1400 may minimize the average JCT using the first method, or may minimize the average JCT using the second method.

The training system 1400 according to an embodiment may compare an average JCT predicted when one or more training jobs are executed in multiple phases using the first method with an average JCT predicted when one or more training jobs are executed in a single phase using the second method. If the average JCT when the training job is executed in multiple phases is shorter, the training system 1400 may allocate processing units using the first method. If the average JCT when the training job is executed in a single phase is shorter, the training system 1400 may allocate processing units using the second method.

Hereinafter, in the disclosure, the first method in which the average JCT decreases as the average job is executed in multiple phases will be described.

When the queuing training job is present, the training system 1400 according to an embodiment may compare a queuing time of the queuing training job with an expected increase time when one or more training jobs are executed from a single phase to multiple phases. When the queuing time of the queuing training job is longer than the expected increase time when one or more training jobs are executed in multiple phases, the training system 1400 may reallocate the processing unit to the queuing training job.

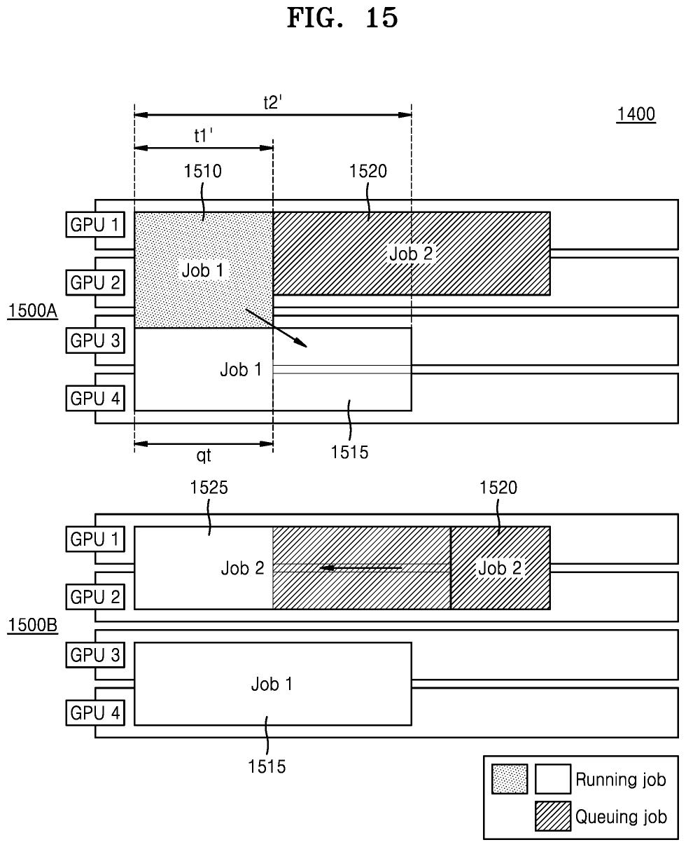

The training system 1400 according to an embodiment may consider the queuing training job alone as one or more training jobs executed from a single phase to multiple phases (FIG. 14) and also consider the queuing training job and the training job to which resources are pre-allocated (FIG. 15).

The training system 1400 according to an embodiment may compare a queuing time qt of the queuing training job 1420 stored in a queue with an expected increase time t2−t1 when the queuing training job 1420 is executed in multiple phases. The expected Increase time t2−t1 when the queuing training job 1420 is executed in multiple phases may correspond to a difference between an execution time t2 during which the queuing training job 1420 is executed in multiple phases and an execution time t1 during which the queuing training job 1420 is executed in a single phase.

When the queuing time qt of the queuing training job is longer than the expected increase time t2−t1 when the queuing training job is executed in multiple phases, the training system 1400 according to an embodiment may execute the queuing training job 1420 in multiple phases. For example, the training system 1400 may allocate an idle processing unit to the queuing training job 1420.

The idle processing unit may mean a processing unit that is not used by any program until other processing units complete an iteration. The idle processing unit may respond to fragmentation of a cluster. For example, the first processing unit GPU1 may correspond to an idle processing unit.

For example, referring to 1400A and 1400B, the queuing time qt of the queuing training job 1420 may be 100 seconds, the execution time t1 during which the queuing training job 1420 is executed in one phase by two GPUs (GPU1 and GPU2) may be 60 seconds, and the execution time t2 during which the second training job 1425 is executed in two phases by one GPU (GPU1) may be 110 seconds. The expected increase time t2−t1 may be 50 seconds. As such, communication overhead of the training system 1400 decreases, and thus a time during which a training job is executed in multiple phases, e.g., two phases (e.g., 110 seconds) may be twice a time during which the training job is executed in a single phase (e.g., 60 seconds) or less than twice the time.

For example, when the queuing time qt (e.g., 100 seconds) is longer than the expected increase time t2−t1 (e.g., 50 seconds), the training system 1400 may allocate the first processing unit GPU1 to the second training job 1420 queuing in a queue to reduce the average JCT. The second training job 1425 to which the first processing unit GPU1 is allocated may be executed in two phases by the first processing unit GPU1.

The training system 1400 may execute the first training job 1410 and the second training job 1420 in parallel. When the second training job 1420 is executed in two phases, a work time increases compared with when the second training job 1420 is executed in one phase, but the queuing time qt of the second training job 1420 is reduced to a greater extent, and thus the average JCT of the training system 1400 may be reduced. When the queuing time qt is less than the expected increase time t2−t1, if the idle processing unit is allocated to the queuing training job 1420, the average JCT increases, and thus the training system 1400 may reserve other processing units other than the idle processing unit. The training system 1400 may allocate the reserved other processing units to the queuing training job 1420. This will be described below with reference to FIG. 15.

When there is the queuing training job in a queue, the training system 1400 according to an embodiment may allocate less resources than resources required for the queuing training job queuing in the queue using the idle processing units. The training system 1400 may minimize the average JCT of the plurality of training jobs by reducing a queuing time of the queuing training job queuing in the queue.

FIG. 15 shows an example of a process of allocating processing units to a plurality of training jobs in a training system according to an embodiment.

With reference to FIG. 15, an example of the case in which two training jobs 1510 and 1520 are submitted to the training system 1400 according to an embodiment and four GPU resources (GPU1, GPU2, GPU3, and GPU4) are present in a cluster will be described.

The training system 1400 according to an embodiment may allocate resources using the SRSF method. For example, the remaining service time of a first training job 1510 may be less than the remaining service time of a second training job 1520.

Referring to 1500A, the training system 1400 may preferentially allocate as many resources (e.g., four GPUs) that are required for the first training job 1510. The second training job 1520 may queue in a queue of a scheduler. The second training job 1520 may be referred to as a queuing training job.

When the queuing training job is present and the queuing time qt of the queuing training job is less than the expected increase time t2−t1 when the queuing training job is executed in multiple phases, the training system 1400 according to an embodiment may further consider whether to execute a training job, to which resources are pre-allocated, in multiple phases using the first method. For example, when an average JCT of the first method in which a training job to which resources are pre-allocated is executed in multiple phases is less than an average JCT of the second method in which the training job to which resources are pre-allocated is executed in a single phase, the training system 1400 may reallocate resources to execute the pre-allocated training job in multiple phases. The training job to which resources are pre-allocated may correspond to the first training job 1510.

The training system 1400 according to an embodiment may compare the queuing time qt of the queuing training job 1520 with the expected increase time t2′−t1′ when the first training job 1510 is executed in multiple phases. The expected increase time t2′−t1′ when the first training job 1510 is executed in multiple phases may correspond to a difference between an execution time t2′ during which the first training job 1520 is executed in multiple phases and an execution time t1′ during which the first training job 1520 is executed in a single phase.

When the queuing time qt of the queuing training job 1520 is greater than the expected increase time t2′−t1′ when the first training job 1510 is executed in multiple phases, the training system 1400 may execute the first training job 1510 in multiple phases and reallocate processing units pre-allocated to the first training job 1510, to the queuing training job 1520. The training system 1400 may reserve the pre-allocated processing units other than the idle processing unit and reallocate the pre-allocated processing units to the queuing training job 1520.

For example, referring to 1500A, the queuing time qt of the queuing training job 1520 may be 120 seconds, the execution time t1′ during which the first training job 1510 is executed in one phase by four GPUs (GPU1, GPU2, GPU3, and GPU4) may be 120 seconds, and the execution time t2′ during which a first training job 1515 is executed in two phases by two GPUs (GPU1 and GPU2) may be 200 seconds. The expected increase time t2′−t1′ may be 80 seconds.

For example, when the queuing time qt (e.g., 120 seconds) is greater than the expected increase time t2′−t1′ (e.g., 120 seconds), two GPUs (e.g., GPU1 and GPU2) among four pre-allocated GPUs may be reserved as the available processing unit to reduce the average JCT. The first training job 1515 may be executed in two phases by the other two GPUs (e.g., GPU3 and GPU4) among the four pre-allocated GPUs.

Referring to 1500B, the training system 1400 may allocate two GPUs (e.g., GPU1 and GPU2) reserved in the queuing training job 1520 queuing in a queue. Two GPUs (e.g. GPU1 and GPU2) may be allocated to the queuing training job 1525.

The training system 1400 may execute the training job to which resources are pre-allocated and the queuing training job in parallel using resources reserved from the training job to which resources are pre-allocated instead of executing the queuing training job after completing the training job to which resources are pre-allocated. When the first training job 1510 is executed in two phases, a work time increases compared with when the first training job 1510 is executed in one phase, but the queuing time qt of the queuing training job 1520 is reduced to a greater extent, and thus the average JCT of the training system 1400 may be reduced.

The training system 1400 according to an embodiment may reduce the queuing time of the queuing training job queuing in a queue by reallocating the processing unit pre-allocated to the first training job, to the queuing training job. As a result, the average JCT of the plurality of training jobs may be minimized.

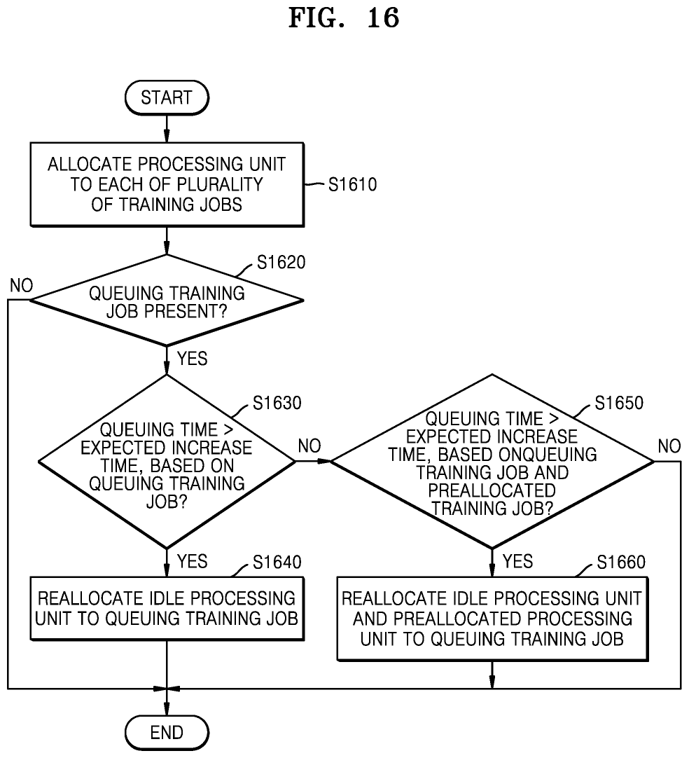

FIG. 16 is a flowchart of a method of allocating processing units to a plurality of training jobs in a training system according to an embodiment.

Referring to FIG. 16, in operation S1610, the training system 1400 may allocate a processing unit to each of the plurality of training jobs through a resource manager. The training system 1400 may allocate resources using the SRSF method. The training system 1400 may allocate resources using the max-min fairness method. The training system 1400 may allocate resources in consideration of the max-min fairness and the SRSF method at the same time like operation S1310 of FIG. 13.

In operation S1620, the training system 1400 may identify whether there is a queuing training job. The queuing training job may refer to a training job to which no resource is allocated and which is stored in a queue and queues. The queuing training job may queue in the queue until resources are scheduled and processed.

When there is a queuing training job, the training system 1400 may perform a resource allocation operation, for example, operations S1630 to S1660. The training system 1400 may complete the resource allocation operation when there is no queuing training job.

According to an embodiment, when comparing the first method in which the training job is executed in multiple phases with the second method in which the training job is executed in a single phase, the training system 1400 may consider the queuing training job alone (operations S1630 and S1640). A related example is described above with reference to FIG. 14.

According to an embodiment, when comparing the first method in which the training job is executed in multiple phases with the second method in which the training job is executed in a single phase, the training system 1400 may consider the queuing training job and the training job to which resources are pre-allocated (operations S1650 and S1650). A related example is described above with reference to FIG. 15.

In operation S1630, as the queuing training job is present, the training system 1400 may determine whether to execute the queuing training job in multiple phases by comparing the queuing time qt of the queuing training job with the expected increase time t2−t1 when the queuing training job is executed in multiple phases.

In operation S1640, when the queuing time qt of the queuing training job is longer than the expected increase time t2−t1 when the queuing training job is executed in multiple phases, the training system 1400 may execute the queuing training job in multiple phases. For example, the training system 1400 may allocate an idle processing unit to the queuing training job.

When the queuing training job is executed in multiple phases, the average JCT of the plurality of training jobs may be reduced.

When the queuing time qt is less than the expected increase time t2−t1, the training system 1400 may reserve other processing units other than the idle processing unit. For example, the training system 1400 may reallocate the processing unit pre-allocated to any training job to the queuing training job. The training system 1400 may determine whether to execute the corresponding training job in multiple phases in consideration of the training job to which resources are pre-allocated as well as the queuing training job. This will be described with reference to operation S1650.

In operation S1650, when the queuing time qt of the queuing training job is less than the expected increase time t2−t1 when the queuing training job is executed in multiple phases, the training system 1400 may compare the queuing time qt of the queuing training job with the expected increase time t2′−t1′ when the training job to which the processing unit is allocated is executed in multiple phases. In FIG. 16, the training job to which resources are allocated is referred to as a first training job.

The training system 1400 may determine whether to execute the first training job in multiple phases by comparing the queuing time qt stored in the queue with the expected increase time t2′−t1′.

In operation S1660, when the queuing time qt of the queuing training job is greater than the expected increase time t2′−t1′, the training system 1400 may execute the first training job in multiple phases.

For example, the training system 1400 may reallocate at least one processing unit pre-allocated to the first training job, to the queuing training job. For example, the training system 1400 may reallocate the queuing training job by reserving the processing unit pre-allocated to the first training job. Accordingly, less resources than the required resources may be allocated to the first training job, and the first training may be executed in multiple phases. Alternatively, the training system 1400 may allocate the idle processing unit to the queuing training job.

When the queuing time qt is less than the expected increase time t2′−t1′, the training system 1400 may not rearrange the processing unit pre-allocated to the first training job to the queuing training job.

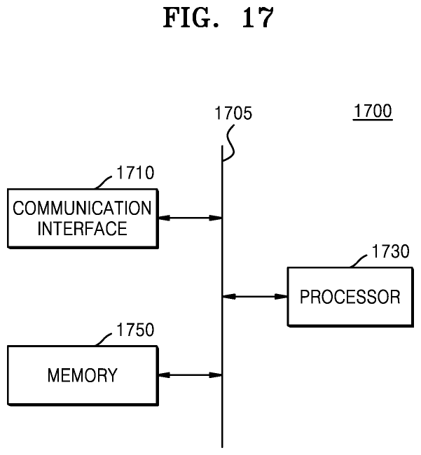

FIG. 17 is a block diagram of a training system according to an embodiment.

Referring to FIG. 17, the training system 1700 according to an embodiment may include a communication interface 1710, a processor 1730, and a memory 1750. The communication interface 1710, the processor 1730, and the memory 1750 may communicate with each other through a communication bus 1705. The training system 1700 according to one embodiment may correspond to each of the training system 100, the training system 1100, and the training system 1400.

The communication interface 1710 may receive a training request containing training data from a user.

The processor 1730 may partition the training job into a plurality of microservices executed by a plurality of logical workers of a neural network model in response to the training request. The processor 1730 may dynamically allocate a plurality of microservices to a plurality of graphics processing units based on the availability status of the graphic processing unit. In consideration of a resource situation of the cluster, when the number of processing units in an availability status is less than the number of logical workers required to execute the training job, the processor 1730 may schedule the plurality of microservices to the same processing unit. The processor 1730 may train a neural network model by a plurality of logical workers based on scheduling.

The processor 1730 partitions the training job corresponding to the neural network model into a plurality of microservices executed by a plurality of logical workers. The processor 1730 schedules the plurality of microservices to the plurality of processing units. The processor 1730 may schedule the plurality of first microservices and the plurality of second microservices to any one processing unit among the plurality of processing units based on the availability status of the plurality of processing units.

The training system 100 may sequentially schedule the plurality of first microservices and the plurality of second microservices to any one processing unit based on that the number of available processing units is less than the number of logical workers.

The processor 1730 may schedule the plurality of first microservices and the plurality of second microservices to the same container.

The processor 1730 may schedule minibatch processing of any one of the plurality of first microservices and minibatch processing of any one of the plurality of second microservices to be executed in multiple phases in any one processing unit.

The processor 1730 may allocate the plurality of processing units in units of 2ⁿ to the training job corresponding to the neural network model.

When the training job corresponding to the neural network model includes 2k logical workers, the processor 1730 may allocate the plurality of processing units in units of any one of divisors of 2k. The processor 1730 may allocate the plurality of processing units in units of any one of divisors of 2k−1 or divisors of 2k, except for 1 and 2k when the training job includes 2k−1 logical workers.

The processor 1730 may allocate a processing unit present in a cluster in the order from the training job with the shortest remaining service time. As there is the remaining processing unit in the cluster, the processor 1730 may allocate the remaining processing unit to the training job to which less processing units than required processing units are allocated, to the remaining processing unit.

The processor 1730 may allocate a processing unit to each of the plurality of training jobs. The processor 1730 may identify whether there is a queuing training job stored in a queue. As the queuing training job is present, if the queuing time of the queuing training job is greater than the expected increase time when the one or more training jobs are executed in multiple phases, the processor 1730 may reallocate the processing unit to the queuing training job. At least one training job may include at least one of the queuing training job and the first training job to which the processing unit is pre-allocated.

For example, the processor 1730 may determine whether the idle processing unit is allocated to the queuing training job by comparing the queuing time of the queuing training job with the expected increase time when the queuing training job is executed in multiple phases.

For example, the processor 1730 may determine whether to reallocate the processing unit pre-allocated to the first training job to the queuing training job by comparing the queuing time of the queuing training job with the expected growth time when the first training job to which the processing unit is pre-allocated is executed.

The memory 1750 may store various information generated in a process of processing the processor 1730 described above. The memory 1750 may store various data and programs. The memory 1750 may include a volatile memory or a nonvolatile memory. The memory 1750 may store various data by providing large-capacity storage media such as hard disks.

The processor 1730 may perform the at least one method described above with reference of FIGS. 1 to 16 and an algorithm corresponding to the at least one method. The processor 1730 may be a data processing device implemented by hardware having a circuit having a physical structure for executing the desired operations. For example, the desired operations may include codes or instructions contained in a program. For example, a predictive device implemented by hardware may include a microprocessor, a central processing unit, a processor core, a multi-core processor, a multiprocessor, an application-specific integrated circuit (ASIC), or a field programmable gate array (FPGA).

The processor 1730 may execute a program and control the training system 1700. The program code executed by the processor 1730 may be stored in the memory 1750. The processor 1730 may include, for example, a central processing unit (CPU), a graphics processing unit (GPU), or a neural network processing unit (NPU).

A device readable-storage medium may be provided in the form of a non-transitory storage medium. The “non-transitory storage medium” is a tangible device and does not include a signal (e.g., electromagnetic waves), which is not distinguished between the case in which data is semi-permanently stored in a storage medium and the case in which data is temporarily stored. For example, “non-transitory storage medium” may include a buffer in which data is temporarily stored.

According to an embodiment, a method according to various embodiments disclosed herein may be included in a computer program product and provided. The computer program product may be traded as a product between sellers and buyers. The computer program product may be distributed in the form of a device-readable storage medium (e.g., compact disc read only memory (CD-ROM)), or may be distributed through an application store or between two user devices (e.g., smartphones) directly or online (e.g., download or upload). In the case of online distribution, at least some of the computer program products (e.g., downloadable app) may be at least temporarily stored or temporarily generated in a device-readable storage medium such as memories of a server of a manufacturer, a server of an application store, or a relay server.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A training system comprising:
a job proxy configured to partition a training job corresponding to a neural network model into a plurality of microservices respectively executed by a plurality of logical workers; and
a scheduler configured to schedule the plurality of microservices to a plurality of processing units, respectively,
wherein the plurality of microservices include a plurality of first microservices executed by a first logical worker among the plurality of logical workers and a plurality of second microservices executed by a second logical worker among the plurality of logical workers, and
the scheduler is configured to schedule the plurality of first microservices and the plurality of second microservices to any one processing unit among the plurality of processing units based on an availability status of the plurality of processing units.

2. The training system of claim 1,
wherein the scheduler is further configured to sequentially schedule the plurality of first microservices and the plurality of second microservices to the any one processing unit in accordance with a number of available processing units being less than a number of the plurality of logical workers.

3. The training system of claim 1,
wherein the scheduler is configured to schedule the plurality of first microservices and the plurality of second microservices to a same container.

4. The training system of claim 1,
wherein the plurality of microservices each include a function that processes a plurality of minibatches obtained by partitioning training data for the training job, and
the scheduler is configured to schedule minibatch processing of any one of the plurality of first microservices and minibatch processing of any one of the plurality of second microservices to be executed in multiple phases in the any one processing unit.

5. The training system of claim 1,
further comprising a resource manager,
wherein the resource manager is configured to allocate the plurality of processing units in units of 2ⁿ to the training job corresponding to the neural network model (wherein n is 0 or a natural number).

6. The training system of claim 1,
further comprising a resource manager,
wherein, when the training job corresponding to the neural network model includes 2k logical workers, the resource manager is configured to allocate the plurality of processing units in units of any one of divisors of 2k, and
when the training job includes 2k−1 logical workers, the resource manager is configured to allocate the plurality of processing units in units of any one of divisors of 2k−1 or divisors of 2k, except for 1 and 2k (wherein k is a natural number).

7. The training system of claim 1,
further comprising a resource manager configured to respectively allocate the plurality of processing units to the plurality of training jobs corresponding to a plurality of neural network models,
wherein the resource manager is further configured to
allocate a processing unit present in a cluster in an order from a training job having a shortest remaining service time
and allocate a remaining processing unit to a training job to which less processing units than required processing units are allocated in accordance with presence of the remaining processing unit in the cluster.

8. The training system of claim 1,
further comprising a resource manager configured to respectively allocate the plurality of processing units to the plurality of training jobs corresponding to a plurality of neural network models,
wherein the resource manager is configured to
allocate a processing unit to each of the plurality of training jobs
and reallocate the processing unit to a queuing training job when a queuing time of a queuing training job is greater than an expected increase time when one or more training jobs are executed in multiple phases, in accordance with presence of the queuing training job stored in a queue.

9. The training system of claim 1,
wherein the plurality of microservices includes
a computation function that computes respective weights for a plurality of minibatches, and
an aggregation function that computes a global parameter obtained by aggregating the respective weights for the plurality of minibatches.

10. The training system of claim 9,
wherein a first computation function of the plurality of first microservices and a second computation function of the plurality of second microservices are sequentially executed in a same iteration.

11. The training system of claim 9,
wherein a first computation function of the plurality of first microservices reads the global parameter and transfers the global parameter to a second computation function of the plurality of second microservices.

12. The training system of claim 1,
wherein the plurality of microservices includes a plurality of third microservices executed by a third logical worker among the plurality of logical workers and a plurality of fourth microservices executed by a fourth logical worker among the plurality of logical workers,
the scheduler schedules the plurality of third microservices and the plurality of fourth microservices to another processing unit among the plurality of processing units, and
the plurality of third microservices are executed in parallel with the plurality of first microservices.

13. An operating method of a training system, the operating method comprising:
partitioning a training job corresponding to a neural network model into a plurality of microservices respectively executed by a plurality of logical workers; and
scheduling the plurality of microservices to a plurality of processing units, respectively,
wherein the scheduling includes scheduling a plurality of first microservices executed by a first logical worker among the plurality of logical workers and a plurality of second microservices executed by a second logical worker among the plurality of logical workers to any one processing unit among the plurality of processing units based on an availability status of the plurality of processing units.

14. The operating method of claim 13,
wherein the scheduling includes sequentially scheduling the plurality of first microservices and the plurality of second microservices to the any one processing unit when a number of available processing units is determined to be less than a number of the plurality of logical workers.

15. The operating method of claim 13,
wherein the scheduling includes scheduling the plurality of first microservices and the plurality of second microservices to a same container.

16. The operating method of claim 13,
further comprising scheduling minibatch processing of any one of the plurality of first microservices and minibatch processing of any one of the plurality of second microservices to be executed in multiple phases in the any one processing unit.

17. The operating method of claim 13,
further comprising allocating the plurality of processing units in units of 2ⁿ to the training job corresponding to the neural network model (wherein n is 0 or a natural number).

18. The operating method of claim 13,
further comprising respectively allocating the plurality of processing units to the plurality of training jobs corresponding to a plurality of neural network models,
wherein the respectively allocating of the plurality of processing units to the plurality of training jobs includes
allocating a processing unit present in a cluster in an order from a training job having a shortest remaining service time, and
allocating a remaining processing unit to a training job to which less processing units than required processing units are allocated as the remaining processing unit is present in the cluster.

19. The operating method of claim 13, further comprising:
respectively allocating the plurality of processing units to the plurality of training jobs corresponding to a plurality of neural network models; and
reallocating the processing unit to a queuing training job if a queuing time of a queuing training job is greater than an expected increase time when one or more training jobs are executed in multiple phases, in accordance with presence of the queuing training job stored in a queue.

20. The operating method of claim 13,
wherein the plurality of microservices includes a plurality of third microservices executed by a third logical worker among the plurality of logical workers and a plurality of fourth microservices executed by a fourth logical worker among the plurality of logical workers, and
the scheduling includes scheduling the plurality of third microservices and the plurality of fourth microservices for another processing unit among the plurality of processing units, and
executing the plurality of third microservices in parallel with the plurality of first microservices.
